(19) United States
(12) Patent Application Publication
(10) Pub. No.: US 2004/0165081 A1
(43) Pub. Date: Aug. 26, 2004

(54) Image processing apparatus, image processing system, and image processing method

(76) Inventors: Hiroyuki Shibaki, Tokyo (JP); Noriko Miyagi, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/727,663

(22) Filed: Dec. 5, 2003

(30) Foreign Application Priority Data
Dec. 5, 2002 (JP) 2002-353335
Feb. 18, 2003 (JP) 2003-039544

(51) Int. Cl. H04N 5/228

(52) U.S. Cl. 348/222.1

(57) ABSTRACT

An input unit inputs color image signals, a first segmentation unit determines attributes of a target pixel for the color image signals, a color component control unit that conducts a predetermined processing to color components of the target pixel based on the attributes of the target pixels determined to thereby generate processed color image signals, a second segmentation unit that determines attributes of the target pixel for the processed color image signals, and an image processing unit that conducts an image processing to the processed color image signals based on the attributes of the target pixel determined by the second segmentation unit.

### CROSS-REFERENCE TO RELATED APPLICATIONS

The present document incorporates by reference the entire contents of Japanese priority documents, 2002-353335 filed in Japan on Dec. 5, 2002 and 2003-039544 filed in Japan on Feb. 18, 2003.

### BACKGROUND OF THE INVENTION

1) Field of the Invention

The present invention relates to an image processing apparatus, an image processing system, and an image processing method used for a printer, a digital copying machine, a facsimile machine, a compound function image processing apparatus, a multifunction printer (hereinafter, “MFP”) or the like.

2) Description of the Related Art

An image processing apparatus which merges image signals with a segmentation signal by setting signal values representing an achromatic color to pixels that are black character area pixels is know in the art, see Japanese Patent Application Laid-open No. H8-98016. In the image processing apparatus disclosed in this publication, when merging the image signals with the segmentation signal, black character pixels are corrected so as to satisfy R=G=B, and the pixels that satisfy R=G=B are re-extracted by an extraction section. This publication also discloses a fusion method by setting signals a and b at zero in a Lab colorimetric system, and a fusion method of merging black character information with the image signals by setting the signals at special values (R=255, G=B=0, etc) which are not used for an ordinary color image. This publication further discloses that the pixels are generally determined using a result of extracting peripheral pixels so as to remove erroneously detected pixels at the time of re-extraction.

In the conventional color image processing apparatus functions to create and output an enlarged or reduced image by user's designating a variable magnification using an operation panel or the like or user's designating an output sheet size at the time of designating the sheet and changing the magnification for the sheet.

For example, most of currently available image processing apparatuses are constituted to change over a line rate of a line sensor at the time of data input by a scanner to thereby perform a magnification setting processing in a sub-scan direction or conduct a signal processing to input digital image signals to thereby perform a magnification setting processing (an electric magnification setting processing) in a main scan direction.

Other types of image processing apparatuses conduct the electric magnification setting processing in both the main scan direction and the sub-scan direction or execute a combination of the mechanical magnification setting processing and the electric magnification setting processing in the sub-scan direction. In this specification, for brevity of explanation, the former image processing apparatus, i.e., the currently available image processing apparatus conducting a one-dimensional magnification setting processing in the main scan direction on digital image signals will be explained unless specified otherwise. Needless to say, the present invention can be applied to the latter image processing apparatus conducting a two-dimensional magnification setting processing in the main scan direction and the sub-scan direction.

As the electric magnification setting method for the color image signals, a nearest neighbor interpolation method, a linear interpolation method, a cubic convolution interpolation method, and the like are well known. The nearest neighbor interpolation method is a method of interpolating image data on an image which is not subjected to a magnification setting and which is located at the nearest position to an interpolation position. The linear interpolation method is a method of determining values obtained by a linear calculation, with a distance used as a parameter, from image data on images which are not subject to the magnification setting and which are located on both sides of an interpolation position, respectively as interpolation data. The cubic convolution method is a method of determining a sum of cubic function values, with distances from an interpolation position to their respective input data used as parameters.

As conventional image processing apparatuses, the following apparatuses or systems are known. An image processing system which performs a segmentation processing accompanied by color determination before subjecting image data to the magnification setting processing is disclosed in, for example, Japanese Patent Application Laid-open No. H8-102810 (see P3 to P18 and FIG. 3). An image processing apparatus which performs the segmentation processing accompanied by the color determination after the image data is subjected to the magnification setting processing is disclosed by, for example, Japanese Patent Publication No. 3176052 (see P3 to P8 and FIG. 3). An image processing apparatus disclosed in, for example, Japanese Patent Application Laid-Open No. H8-98016, Japanese Patent Application Laid-open No. H8-98016 (see P3 to P5 and FIG. 2), which detects a black character area by the segmentation processing in response to a request to hold predetermined code information (which is not limited to color information) at the time of conducting the magnification setting to the image data, buries achromatic color signals (e.g., those satisfying a*=b*=c for L*a*b*) that represent code information in the detected black character area, stores, transmits or receives one piece of image data obtained by merging the image data with the segmentation data in a memory, and which extracts the buried code information from the image data.

As explained, according to the conventional art (e.g., Japanese Patent Application Laid-open No. H8-98016), the achromatic color pixel generation processing such as a processing for generating achromatic color pixels satisfying R=G=B or a=b=0 in the Lab calorimetric system is conducted to black character pixels and a segmentation result extraction unit detects (re-extracts) the black character information based on the achromatic color pixel information. However, the conventional art has a disadvantage in that the segmentation result extraction unit cannot detect (re-extract) the black character information with high accuracy only by means of the achromatic color pixel generation processing.

Further, according to the conventional color image processing apparatuses, the nearest neighbor interpolation or the linear interpolation method has advantages of a simple arithmetic operation and a narrow reference area as hardware application. However, the method has a disadvantage in that a magnification setting processing produces strong moire on halftone dots.

It is supposed that the cubic convolution interpolation which hardly causes moire is effective for obtaining high quality magnification-set image. However, a color determination apparatus which typically discriminates a black character by this segmentation has the following advantages and disadvantages, depending on the positional relationship between the color determination and the magnification setting.

The image processing apparatus represented by that disclosed in Japanese Patent Application Laid-open No. H8-98016 is disadvantageously required to enlarge or reduce the segmentation result as the image data is enlarged or reduced.

The image processing apparatus represented by that disclosed in Japanese Patent Application Laid-open No. H8-102810 conducts the color determination to the enlarged image, with the result that the determination performance of the apparatus is disadvantageously, considerably deteriorated.

FIGS. 26A to 26C are graphs which illustrate out-of-color registration quantities generated in a black character edge of an image if the image is subjected to the magnification setting. FIG. 26A illustrates the relationship between a scanner input value and a pixel position. FIG. 26B illustrates the relationship between enlarged data and a pixel position in a comparison. FIG. 26C illustrates the relationship between the enlarged data and the pixel position according to the present invention. As shown in FIG. 26A, if out-of-color registration (out-of-color registration quantity=M) occurs to the black character edge of the image and the magnification of the image is increased by the cubic convolution interpolation as shown in FIG. 26B, the out-of-color registration quantity considerably increases (out-of-color registration quantity>>M×expansion ratio). Namely, in order to discriminate this black character edge as a black color, quite a wide area must be referred to. If the black color edge is a hair stroke, it is difficult to discriminate the edge as a black color area even by referring to the wide area.

As shown in FIG. 26C, if an increase in out-of-color registration quantity can be suppressed to satisfy (out-of-color registration quantity M×expansion ratio), then considerable deterioration of the color determination accuracy for the enlarged image is avoided, enlargement/reduction of the segmentation result does not occur, an apparatus capable of ensuring a high color determination performance can be realized, and a small-sized, high-quality apparatus that utilizes various advantages of the conventional apparatus can be provided.

If the apparatus disclosed by each of the Japanese Patent Application Laid-open Nos. H8-98016 and H8-102810 conducts the magnification setting processing to the image buried with the code information, it is advantageously unnecessary to conduct the magnification setting processing to the segmentation result besides the image data. For example, if the code information is intended to be extracted with high accuracy when the apparatus performs processings in the order of “burying of code magnification setting extraction of code”, such a magnification setting processing as to hold information on the achromatic color signals (a*=b*=0) is required even after the magnification setting.

FIGS. 27A, 27B, and 27C are graphs which illustrate an example in which code information that represents a black character as the achromatic color information is buried in the image and the image is reduced. FIG. 27A illustrates the relationship between the scanner input value and the pixel position. FIG. 27B illustrates the relationship between the reduced data and the pixel position in the comparison. FIG. 27C illustrates the relationship between the reduced data and the pixel position according to the present invention. As shown in FIG. 27A, it is assumed that the code information that represents the black character as the achromatic color information is buried in the image with a code buried width set at N. If the image is reduced and a reduction ratio is high, the code buried width is considerably smaller than N×reduction ratio (code buried width<<N×reduction ratio). As shown in FIG. 27B, if the black character edge is a hair stroke, the code information may possibly be removed. This sometimes greatly degrades the image quality if the hair stroke is colored when the image is output.

As shown in FIG. 27C, if the code information can be stored while satisfying the relationship of (code buried width N×reduction ratio), the code information effectively works in the black character processing even for the reduced image and a high-quality black character reproduced image can be secured.

### SUMMARY OF THE INVENTION

It is an object of the present invention to solve at least the problems in the conventional technology.

An image processing apparatus according to one aspect of the present invention includes an input unit that inputs color image signals; a first segmentation unit that determines attributes of a target pixel for the color image signals; a color component control unit that conducts a predetermined processing to color components of the target pixel based on the attributes of the target pixels determined to thereby generate processed color image signals; a second segmentation unit that determines attributes of the target pixel for the processed color image signals; and an image processing unit that conducts an image processing to the processed color image signals based on the attributes of the target pixel determined by the second segmentation unit.

An image processing system according to another aspect of the present invention includes an input unit that inputs color image signals; a first segmentation unit that determines attributes of a target pixel for the color image signals; a color component control unit that conducts a predetermined processing to color components of the target pixel based on the attributes of the target pixels determined to thereby generate processed color image signals; a second segmentation unit that determines attributes of the target pixel for the processed color image signals; and an image processing unit that conducts an image processing to the processed color image signals based on the attributes of the target pixel determined by the second segmentation unit.

An image processing method according to still another aspect of the present invention includes inputting color image signals; determining attributes of a target pixel for the color image signals; conducting a predetermined processing to color components of the target pixel based on the attributes of the target pixels determined to thereby generate processed color image signals; determining attributes of the target pixel for the processed color image signals; and conducting an image processing to the processed color image signals based on the attributes of the target pixel determined for the processed color image signals.

An image processing apparatus according to still another aspect of the present invention includes an input unit that inputs color image signals; and a magnification unit that magnifies the color image signals input in such a manner that predetermined color information included in the color image signals before magnifying the color image signals are retained even after magnifying the color image signals.

An image processing apparatus according to still another aspect of the present invention includes an input unit that inputs color image signals in which code information representing a feature of an image is buried; a magnification unit that magnifies the color image signals input in such a manner that the code information buried in the color image signals before magnifying the color image signals are retained even after magnifying the color image signals; and an image processing unit that conducts an image processing to the color image signals magnified.

An image processing method according to still another aspect of the present invention includes inputting color image signals; and magnifying the color image signals input in such a manner that predetermined color information included in the color image signals before magnifying the color image signals are retained even after magnifying the color image signals.

An image processing method according to still another aspect of the present invention includes inputting color image signals in which code information representing a feature of an image is buried; magnifying the color image signals input in such a manner that the code information buried in the color image signals before magnifying the color image signals are retained even after magnifying the color image signals; and conducting an image processing to the color image signals magnified.

The other objects, features and advantages of the present invention are specifically set forth in or will become apparent from the following detailed descriptions of the invention when read in conjunction with the accompanying drawings.

### BRIEF DESCRIPTION OF THE DRAWINGS

FIG. 1 illustrates an example of the configuration of an image processing apparatus according to a first embodiment of the present invention;

FIG. 2 illustrates an example of the configuration of a color component control section;

FIG. 3 illustrates an example of the configuration of a second segmentation section;

FIG. 4 illustrates an example of continuity determination patterns;

FIG. 5 illustrates another example of the color component control section;

FIG. 6 illustrates still another example of the color component control section;

FIG. 7 illustrates still another example of the color component control section;

FIG. 8. illustrates an example of the configuration of an image processing apparatus according to a second embodiment of the present invention;

FIG. 9 illustrates an example of the configuration of an image processing apparatus according to a third embodiment of the present invention;

FIG. 10 illustrates still another example of the color component control section;

FIG. 11 illustrates still another example of the color component control section;

FIG. 12 illustrates an example of the configuration of an image processing apparatus according to a fourth embodiment of the present invention;

FIG. 13 illustrates an example of the configuration of an image processing apparatus according to a fifth embodiment of the present invention;

FIG. 14 illustrates an example of the hardware configuration of the image processing apparatus according to the present invention;

FIG. 15 is a block diagram of a color image processing according to a sixth embodiment of the present invention;

FIG. 16 is an illustration which explains the relationship between a pixel position of an original image and an interpolation position in a magnification setting section shown in FIG. 1;

FIG. 17 is a block diagram which illustrates one example of the configuration of the magnification setting section shown in FIG. 1;

FIG. 18 is a block diagram of the magnification setting section according to a seventh embodiment of the present invention;

FIG. 19 is a block diagram of the magnification setting section according to an eighth embodiment of the present invention;

FIG. 20 illustrates a parameter setting section which differently sets parameters used in a main scan direction magnification setting section and a sub-scan direction magnification setting section;

FIG. 21 is an explanatory view of sections that bury code information in an RGB color image in a color image processing apparatus according to a ninth embodiment of the present invention;

FIG. 22 is an explanatory view of sections that conduct a magnification setting processing to the image in which the code information is buried shown in FIG. 7;

FIG. 23 is a block diagram of a color image processing apparatus according to a tenth embodiment of the present invention;

FIG. 24 is a block diagram of a color image processing apparatus according to a tenth embodiment of the present invention;

FIG. 25 is a block diagram which illustrates another example of another partial configuration of the color image processing apparatus according to the tenth embodiment;

FIGS. 26A, 26B, and 26C are graphs which illustrate out-of-color registration quantities generated in a black character edge of an image when the image is subjected to the magnification setting processing, wherein FIG. 26A illustrates the relationship between a scanner input value and a pixel position, FIG. 26B illustrates the relationship between expanded data and the pixel position in a comparison, and FIG. 26C illustrates the relationship between the expanded data and the pixel position according to the present invention; and

FIGS. 27A, 27B, and 27C are graphs which illustrate an example in which code information that represents a black character is buried, as achromatic color information, in an image and the image is reduced, wherein FIG. 27A illustrates the relationship between the scanner input value and the pixel position, FIG. 26B illustrates the relationship between reduced data and the pixel position in the comparison, and FIG. 26C illustrates the relationship between the reduced data and the pixel position according to the present invention.

### DETAILED DESCRIPTION

Exemplary embodiments of the present invention will be explained hereinafter with reference to the accompanying drawings.

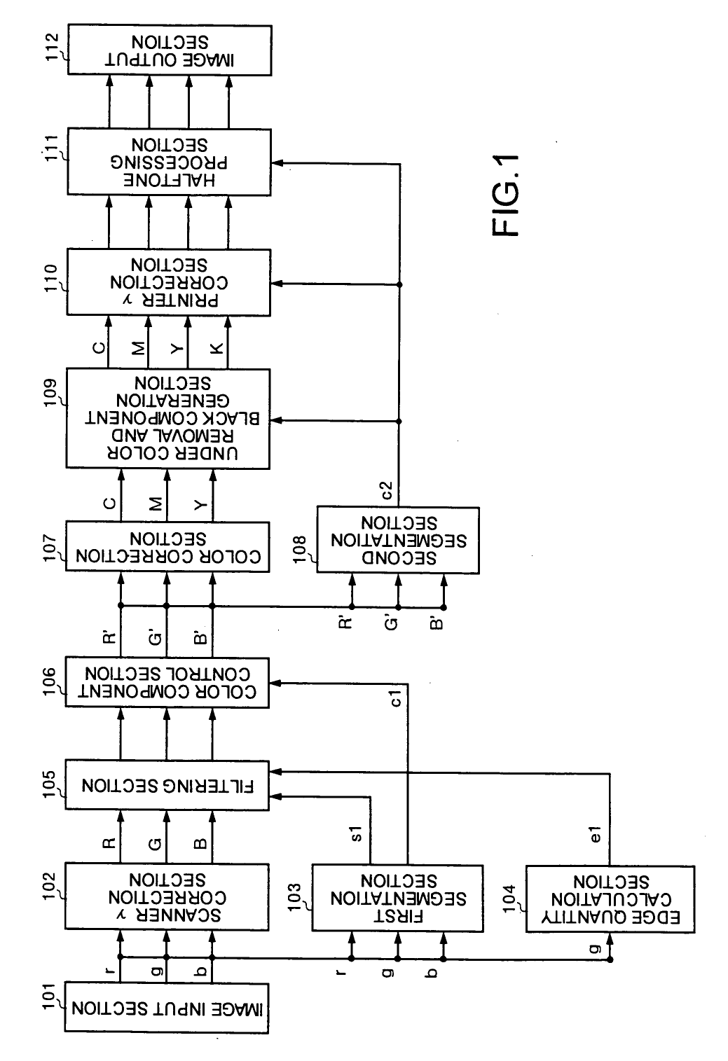

FIG. 1 illustrates an example of the configuration of an image processing apparatus according to a first embodiment of the present invention. This image processing apparatus includes an image input section 101, a scanner γ correction section 102, a first segmentation section (first segmentation unit) 103, an edge quantity calculation section 104, a filtering section 105, a color component control section 106, a color correction section 107, a second segmentation section (second segmentation unit) 108, an under color removal and black component generation section 109, a printer γ correction section 110, a halftone processing section 111, and an image output section 112.

The image processing apparatus according to the first embodiment functions as explained below. An original optically read by the image input section 101 such as a scanner is converted to r, g, and b digital image signals each of eight bits and the digital image signals are output. The output image signals are input to the scanner γ correction section 102 in which the reflectance linear r, g, and b signals are converted to density linear R, G, and B signals by a lookup table (hereinafter “LUT”) or the like. During this conversion, a gray balance is held among the R, G, and B signals so that a gray color can be obtained when R, G, and B have equal pixel values.

The image signals r, g, and b from the image input section 101 are input to the first segmentation section 103 simultaneously with the input of the signals to the scanner γ correction section 102. The first segmentation section 103 segments the image input thereto to a black character image area, a color character image area, and the other pattern areas. The pattern areas refer to a halftone dot image area (a character on halftone dots are discriminated as a pattern area), a continuous tone image area, and a background area.

The first segmentation section 103 performs a segmentation processing based on the segmentation method as disclosed by, for example, Japanese Patent Publication No. 3153221 and Japanese Patent Application Laid-Open No. H5-48892. Namely, according to this segmentation method, comprehensive area determination is conducted based on edge area detection, halftone dot area detection, white background area detection, and chromatic/achromatic color area detection. A character on the white background is discriminated as the character area, and a halftone dot image or a continuous tone image including a character on halftone dots is discriminated as the pattern area (the area other than the character area). The character area is further discriminated as either a black character area or a colored character area by the chromatic/achromatic color area detection. A segmentation signal s1 input to the filtering section 105 is a signal that indicates the character area (character image area). A signal c1 input to the color component control section 106 is a signal that indicates the black character area (black character image area).

The edge quantity calculation section 104 calculates an edge quantity e1 which indicates a degree of an edge of the input image using the g signal.

The filtering section 105 adaptively conducts an edge enhancement processing or a smoothing processing to the R, G,. and B image signals from the scanner γ correction section 102 based on the determination result of the first segmentation section 103 and the edge quantity e1 calculated by the edge quantity calculation section 104. Specifically, the filtering section 105 conducts a uniform edge enhancement filter processing to the character areas (including both the black character area and the colored character area) of the R, G, and B signals, and conducts an adaptive edge enhancement processing to the pattern areas based on the edge quantity after the smoothing processing. By conducting the filtering, the character areas have satisfactory sharpness, the moiré can be suppressed at halftone dots of the pattern areas, and the pattern areas have satisfactory sharpness on the character on the halftone dots.

The color component control section 106 controls color components of the image signals output from the filtering section 105 based on the black character segmentation result (black character area signal) c1 from the first segmentation section 103.

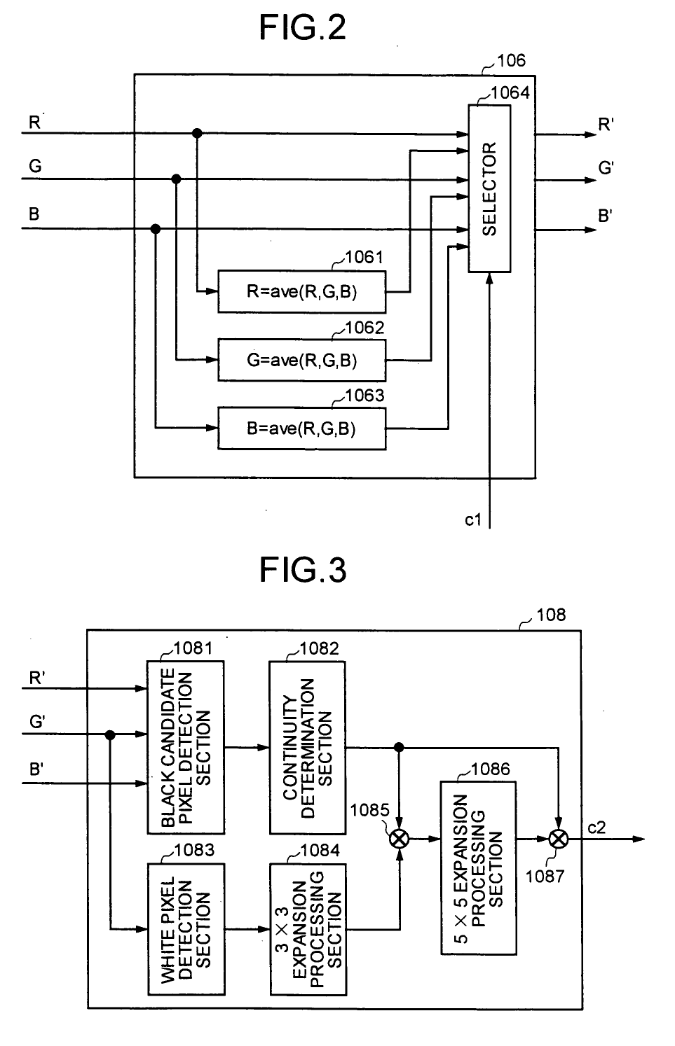

FIG. 2 illustrates an example of the configuration of the color component control section 106. This color component control section 106 includes averaging section 1061 to 1063 that obtain averages of the input R, G, and B signals, respectively and a selector 1065 which switches over the averaged signals from the averaging sections 1061 to 1063 to or from the original R, G, and B signals based on the signal c1. Specifically, the selector 1064 selects the outputs of the averaging sections 1061 to 1063 based on the signal c1 for pixels determined as black character pixels and selects the signals output from the filtering section 105 for pixels which are determined as non-black character pixels, and outputs the selected signals. It is assumed here that if the pixels are black character pixels, signals R′, G′, and B′ satisfy R′=G′=B′=ave(R, G, B), and all the pixels are set equal to thereby provide the signals that indicate the black character. In other words, the color component control section 106 buries a black character code that indicates R′=G′=B′=ave(R, G, B) in the image.

The image signals R′, G′, and B′ output from the color component control section 106 are input to the color correction section 107. The color correction section 106 converts the input image signals R′, G′, and B′ to C, M, and Y signals appropriate as color materials for a printer by a masking operation or the like. While various methods may be used for a color correction processing, it is assumed herein that the masking operation as given by equation 1 is performed:

C=α11×R+α12×G+α13×B+β1 M=α21×R+α22×G+α23×B+β2 Y=α31×R+α32×G+α33×B+β3 (1)

In the equation 1, α11, α21, and α33 and β1, β2, and β3 are preset color correction factors and the output C, M, and Y signals are signals each of eight bits (0 to 255).

The image data output from the color component control section 106 is also input to the second segmentation section 108. The second segmentation section 108 detects (re-extracts) the black character pixels.

FIG. 3 illustrates an example of the configuration of the second segmentation section 108. This second segmentation section 108 includes a black candidate pixel detection section 1081, a continuity determination section 1082, a white pixel detection section 1083, a 3×3 expansion processing section 1084, AND circuits 1085 and 1087, and a 5×5 expansion processing section 1086.

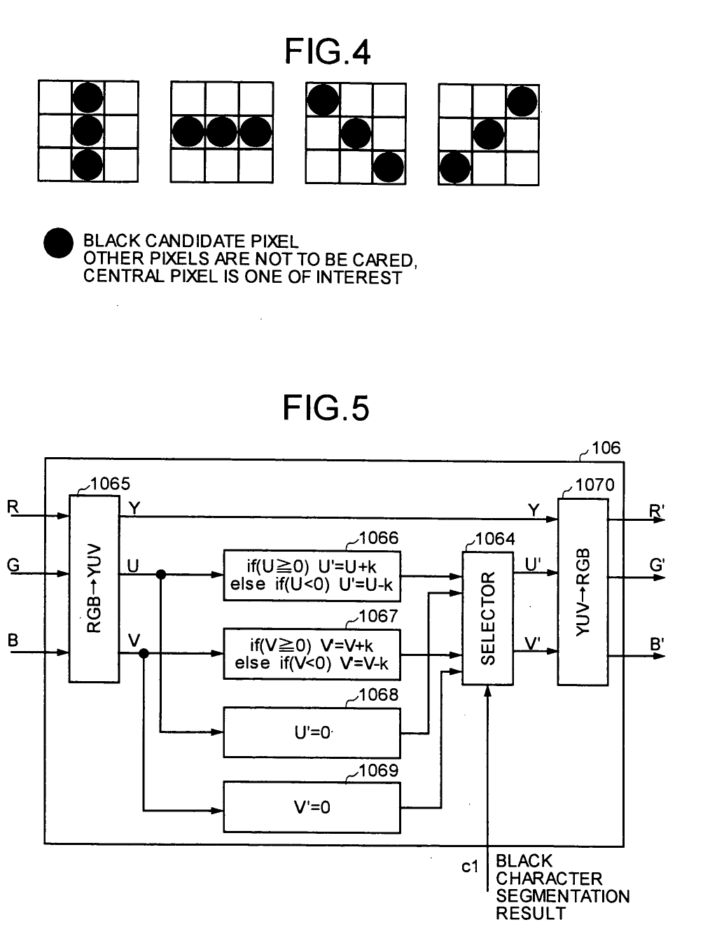

A black character pixel detection processing (re-extraction processing) of the second segmentation section 108 is as follows. The black candidate pixel detection section 1081 determines whether target pixels satisfies R=G=B and G>th1 for the R′, G′, and B′ signals. If the target pixels satisfy R=G=B and G>th1, the black candidate pixel detection section 1081 outputs 1 as black candidate pixels. It is noted that “th1” is a density threshold for determining a black level. The black candidate pixel detection section 1081 detects the black pixels having a predetermined density or more. The detection result of the black candidate pixel detection section 1081 is input to the continuity determination section 1082, and the continuity determination section 1082 performs pattern matching based on patterns shown in, for example, FIG. 4. According to the property of a character image, pixels constituting the black character (black character pixels) are not present as isolated one or two dots. That is, a character has a property that continuous black pixels are aligned in continuous white pixels. For example, the segmentation section disclosed by Japanese Patent Publication No. 3153221 conducts pattern matching using this property. If such detection is conducted in advance, it can be stated definitely that no isolated black pixel is present in the black character area. Therefore, in the example of FIG. 4, the continuity determination section 1082 conducts the pattern matching using 3×3 pixel continuity determination patterns and detects black candidate pixels present as continuous three pixels in a longitudinal, lateral or aslant direction, with a pixel of interest put between the black candidate pixels. It is, thereby, possible to remove the other isolated pixels. In the continuity determination, since the pixels of interest is at the center of the 3×3 pixels, one black pixel is missing on an end point of a line or in a corner of a broken line or a curve. However, no problem occurs since the pixels are eventually detected as the black character pixels by a 5×5 expansion processing conducted later to the black edge on the white background. By conducting the continuity determination, erroneous detection sporadic R=G=B pixels present in the patterns as black character pixels can be avoided.

The white pixel detection section 1083 may be used to further improve the accuracy of the detection . The white pixel detection section 1083 utilizes the feature that white pixels are present around the black character pixels since the black character area refers to the black character on the white background. The white pixel detection section 1083 determines whether the pixels satisfy R=G=B and G<th2. If the pixels satisfy R=G=B and G<th2, the white pixel detection section 1083 outputs 1 as a white pixel. The expansion processing section 1084 expands the white pixel thus detected by 3×3. The AND circuit 1085 calculates a logical AND between an output of the expansion processing section 1084 and the signal output from the continuity determination section 1082. The white pixels form an area in which the pixels are expanded by one pixel from the original white pixel by the 3×3 expansion processing. By obtaining the logical AND between the white pixels and the black character candidate pixels, a black pixel area adjacent to the white background can be detected. Since there are no white pixels around black lumps similar to the black character and sporadic in the patterns, the black lumps can be removed by the processing.

The signals from which R=G=B pixels other than the black character pixels are removed are expanded (to the black character area having a five-dot width) by the 5×5 expansion processing section 1086 and the signals and the signal output from the continuity determination section 1082 are subjected to a logical AND operation by the AND circuit 1087, whereby the black character area (of two dots) protruding to the white background are removed. A black character segmentation signal c2 thus detected corresponds to an area having a three-dot width in an outline of the black character on the white background and the signal c2 is output for used in a later processing.

As the filtering performed before the processing of the second segmentation section 108, a mechanism in which the enhancement processing is sufficiently conducted to the character on the white background, reverse which occurs around the character is purposely left, and in which the reverse which occurs when the enhancement processing is conducted is prevented for black characters on a color background is employed, thereby making it possible to highly accurately detect (re-extract) the black character pixels.

The image signals output from the color correction section 107 are converted to C, M, Y, and K signals by the under color removal and black component generation section 109. The under color removal and black.component generation section 109 generates the K signal that is a black component and conducts under color removal (hereinafter “UCR”) to the C, M, and Y signals. The under color removal and black component generation section 109 conducts different UCR and black component generation processings between the black character pixels and the other pixels based on the black character segmentation result c2 from the second segmentation section 108.

The generation of the K signal and the UCR from the C, M, and Y signals are conducted to the pixels that are not black character pixels (non-black character pixels) according to equation 2:

K=Min (C, M, Y)×β4 C′=C−K×β5 M′=M−K×β5 Y′=Y−K×β5 (2)

In the equation 2, Min(C, M, Y) is a minimum signal among the C, M and Y signals. β4 and β5 are preset factors and each signal has eight bits. Further, the generation of the K signal and the UCR from the C, M, and Y signals are conducted to the black character pixels according to equation 3.

K=Min (C, M, Y) C′=0M′=0Y′=0 (3)

As can be seen, the image is reproduced using a single K toner for the black character pixels. Therefore, a good black character quality can be attained without causing coloration or a decrease of resolution due to the out-of-color registration during printed matter shift.

The signals processed by the under color removal and black component generation section 109 are output to the printer γ correction section 110. The printer γ correction section 110 makes γ correction according to printer engine characteristics and outputs a correction result to the halftone processing section 111. The halftone processing section 111 conducts a halftone processing to the signals, and the image processing section 112 outputs the resultant signals.

In the configuration example of FIG. 1, the halftone processing section 111 switches over a halftone processing method using the segmentation result c2 of the second segmentation section 108. That is, the halftone processing section 111 conducts an error diffusion processing effective to reproduce the sharpness of the character to the pixels determined as black character pixels and a dither processing effective to graininess and tone reproduction to the pixels determined as non-black character pixels. In this embodiment, the halftone processing method is switched over as explained above. However, the error diffusion processing may be performed to the entire pixels.

In the first embodiment, the processing for converting the black character pixels (black character area pixels) to satisfy R=G=B and reducing color components are performed based on the segmentation result of the first segmentation section 103. The second segmentation section 108 detects (re-extracts) the black character pixels based on the R=G=B information. Based on information on the black character pixels thus detected (re-extracted), the later processings such as the UCR and the black component generation processing are performed. It is thereby possible to realize the reproduction of a high quality image.

It has been explained above to completely remove the color components of the black character pixels; however, the present invention is not limited to this. For example, the color component control section 106 can suppress color components so that ΔRGB is a predetermined value or less. In that example, the second segmentation section 108 may detect (re-extract) the black candidate pixels by determining that pixels having ΔRGB of the predetermined value or less are the black candidate pixels. By doing so, the pixels are not completely converted to achromatic color pixels and it is possible to make a user relatively less feel strange about the black character pixels even if the image which has been subjected to the color component processing is displayed on a monitor of a personal computer or the like.

Thus, the first embodiment is characterized by including the first segmentation section which determines the attributes of target pixels for the input color image signals, the color component control section which conducts a predetermined processing to the color components of the target pixels based on the attributes of the target pixels determined by the first segmentation section, and the second segmentation section which determines the attributes of the target pixels for the image signals processed by the color component control section. The color component control section characteristically conducts the predetermined processing to the color components of the target pixels so as to improve accuracy with which the second segmentation section determines the attributes of the target pixels.

Specifically, a first example according to the first embodiment will be explained. The first segmentation section has a black character pixel determination function to determine whether the target pixels are black character pixels based on the attributes thereof. If the first segmentation section determines that the target pixels are not the black character pixels, the color component control section conducts a chromatic color pixel generation processing for increasing the number of color components of the target pixels. The second segmentation section therefore has a function to detect (re-extract) the black character pixels by analyzing at least the color components of the image signals processed by the color component control section.

Namely, in this first example, the color component control section 106 increases the number of color components of non-black character pixels. By doing so, it is possible to decrease the erroneous detection (extraction) of the black character in patterns and realize high accuracy black character detection (extraction).

FIG. 5 is a block diagram of the color component control section 106 in the first example. In the color component control section 106, a block 1065 converts the input RGB signals to YUV signals that are luminance and color difference signals. A conversion equation for RGB to YUV is:

Y=(R+2G+B)/4U=(R−G)/2V=(B−G)/2 (4)

In the YUV signals, the Y signal represents a luminance, and the U and V signals represent color saturation. Namely, the equation 4 is a conversion equation so that if pixels are achromatic color pixels, that is, the pixels satisfy R=G=B, U and V are both zero. Blocks 1066 to 1068, which convert color saturation components, convert color components of the YUV signals obtained by the block 1065, respectively.

The block 1068 is an achromatic color pixel generation section that outputs a U component as zero. Likewise, the block 1069 is an achromatic color pixel generation section that outputs a V component as zero. The block 1066 is, by contrast, a chromatic color pixel generation section that adds a predetermined value k to the U component and outputs the k-added U component when the U is zero or positive, subtracts the predetermined value k from the U and outputs the k-subtracted U when the U is negative, and that thereby increases the color saturation. The value k is preferably set at an appropriate value at a small level at which a color change cannot be visually recognized and at which the target pixels can be sufficiently determined as chromatic color pixels by the second segmentation performed later. Likewise, the block 1067 is a chromatic color pixel generation section that conducts a chromatic color pixel generation processing to the V signal. The Y signal output from the block 1065 is output to a selector 1064 without conducting any processing thereto.

The selector 1064 switches over signals based on the black character segmentation signal c1 output from the first segmentation section 103. Namely, if the black character segmentation signal c1 from the first segmentation section 103 indicates the black character pixels, the selector 1064 selects outputs of the achromatic color generation sections 1068 and 1069. If the signal c1 indicates the non-black character pixels, the selector 1064 selects outputs of the chromatic color generation sections 1066 and 1067. The Y signal and U′ and V′ signals output from the selector 1064 are converted to color component-controlled R′, G′, and B′ signals and output from a block 1070 which converts the YUV signals to RGB signals. A conversion equation for YUV to RGB is:

G=Y−(2U+2V)/4R=2U+G B=2V+G (5)

By constituting the color component control section as shown in FIG. 5, even if pixels indicating an achromatic color or a color quite close to the achromatic color are present in the non-black character area, the pixels are converted to chromatic color pixels by the chromatic color pixel generation section by as much as a sufficient quantity. Therefore, it is possible to improve black character re-extraction accuracy (detection accuracy) in the later processing without giving the user an impression that the color has changed.

A second example according to the first embodiment will be explained now. The first segmentation section has a colored character pixel determination function to determine whether target pixels are colored character pixels based on the attributes thereof. If the first segmentation section determines that the target pixels are colored character pixels, the color component control section conducts a chromatic color pixel generation processing for increasing color components of the target pixels. The second segmentation section has a function to analyze at least the color components of the image signals processed by the color component control section and thereby detect (extract) the colored character pixels.

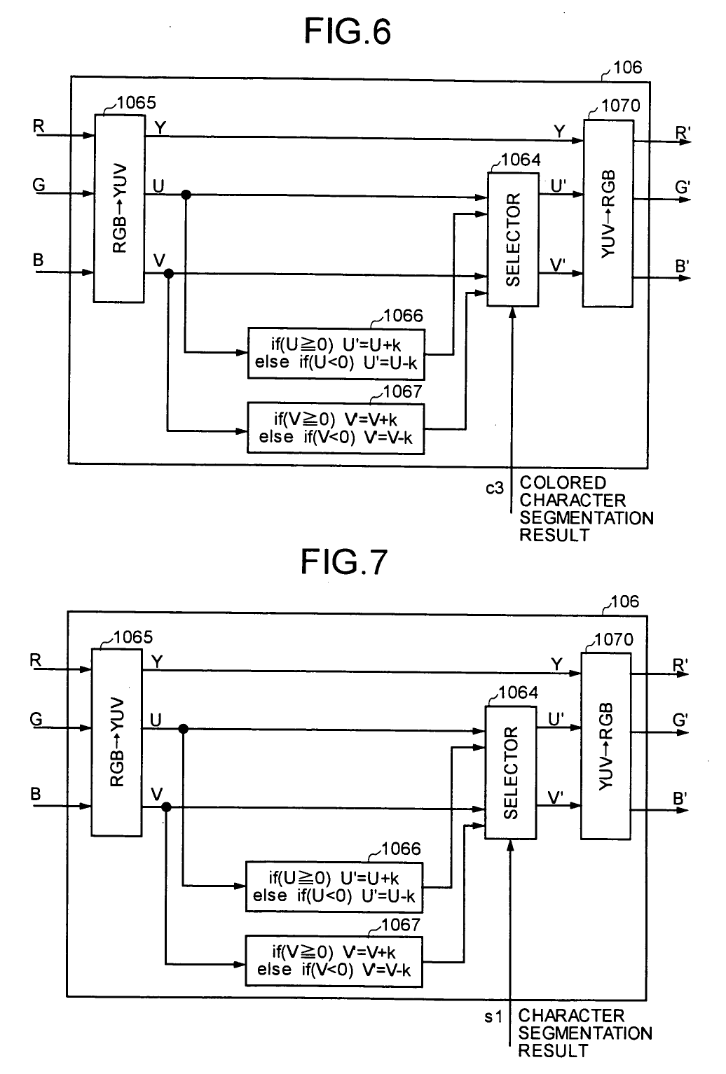

FIG. 6 is a block diagram of the color component control section in the second example. This color component control section 106, similarly to that shown in FIG. 5, includes the chromatic color pixel generation blocks 1066 and 1067 which increase the color saturation. Along the other paths, the input U and V signals are input to the selector 1064 without conducting any processing thereto. The selector 1064 switches over the signals based on the colored character segmentation signal c3 obtained by the determination of the first segmentation section 103. Namely, the selector 1064 selects the signals output from the chromatic color pixel generation blocks 1066 and 1067 for colored character pixels and selects through signals for non-colored character pixels.

By thus increasing the color saturation of the colored character, the colored character is less erroneously determined as a black character in the later second segmentation and black character pixel detection (re-extraction) accuracy can be improved.

A third example according to the first embodiment will be explained now. The first segmentation section has a character pixel determination function to determine whether target pixels are character pixels based on the attributes thereof. If the first segmentation section determines that the target pixels are non-color pixels, the color component control section increases color components of the target pixels. The second segmentation section has a function to analyze at least the color components of the image signals processed by the color component control section and thereby detect (extract) the black character pixels.

FIG. 7 is a block diagram of the color component control section 106 in the third example. The color component control section 106 has the same configuration as that shown in FIG. 6; however, the signal input to the selector 1065 is different. Namely, in the color component control section 106 in the third example, the character segmentation result s1 is input to the selector 1064. The color component control section 106 selects the signals output from the chromatic color pixel generation block 1066 and 1067 for the non-character pixels to thereby increase the color saturation of the non-character pixels, and causes the pixels determined as character pixels (i.e., black character and colored character pixels) to pass through the section 106 without controlling the color saturation components of the achromatic color pixels in the pattern area. This can decrease the erroneous extraction of the achromatic color pixels in the pattern area for the black character pixels.

According to the first embodiment, the color component control section 106 conducts the predetermined processing to the color components of the target pixels so as to improve the accuracy with which the second segmentation section 108 determines the attributes of the target pixels. It is thereby possible to detect (re-extract) black character information with high accuracy, as compared with the conventional apparatus.

Alternatively, these processings can be combined. For example, the color component control section 106 may be configured to perform the achromatic color pixel generation processing for decreasing or removing the color components of the target pixels if the first segmentation section 103 determines that the target pixels are black character pixels in combination with the first example. That is, if the first segmentation section 103 determines that the target pixels are black character pixels, the color component control section 106 can perform the achromatic color pixel generation processing for decreasing or removing the color components of the target pixels. If the first segmentation section 103 determines that the target pixels are non-black character pixels, the color component control section 106 can perform the achromatic color generation processing for increasing the color components of the target pixels. Alternatively, the color component control section 106 may be configured to conduct the achromatic color pixel generation processing to the black character pixels while causing the colored character pixels to pass through the section 106, and conduct the chromatic color pixel generation processing to the non-character area.

It is possible to provide a segmentation circuit that has the same configuration as the first segmentation section 103 in the second segmentation section 108. However, in that case the cost will increase as the first segmentation section 103 is quite costly. By contrast, by burying the information in the image data according to the result of the first segmentation section 103 and processing the data conducting the processing (one of or both of the chromatic color generation processing and the achromatic color generation processing) so that the later segmentation circuit can be made simple in configuration, it is possible to hold down the hardware cost and employ the highly accurate segment signal for the later processing.

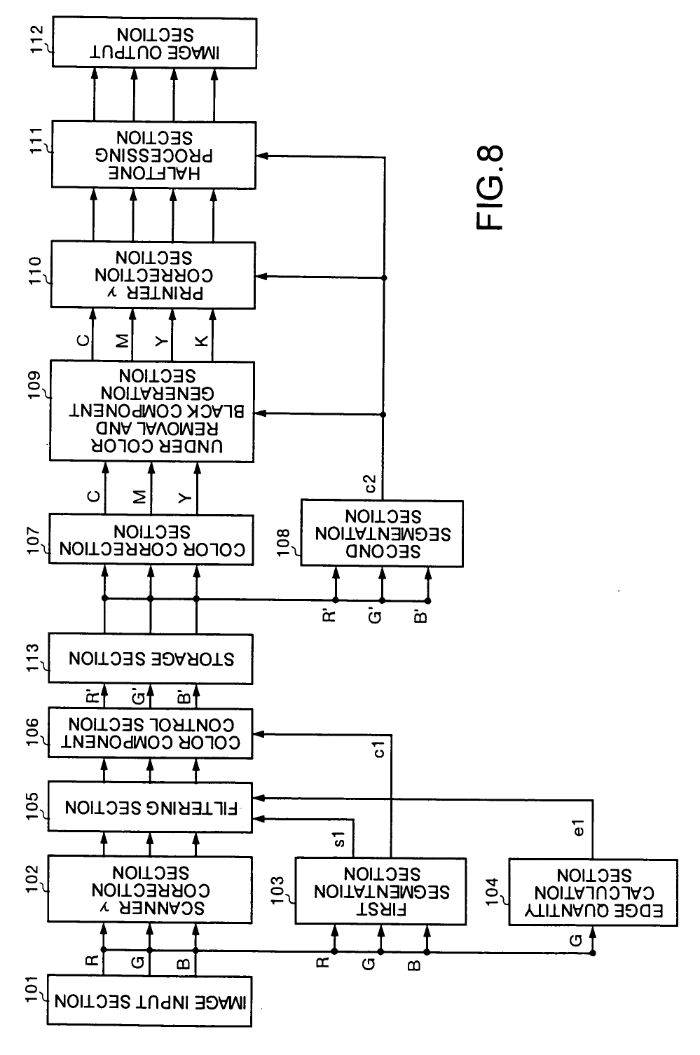

FIG. 8 illustrates an example of the configuration of an image processing apparatus according to a second embodiment of the present invention. This image processing apparatus same configuration as that shown in FIG. 1 except that the outputs of the color component control section 106 are temporarily stored in a storage section 113 and in that the color correction section 107, the second segmentation section 108, and the following sections conduct their processings by reading the signals stored in the storage section 113. In the second embodiment (the image processing apparatus shown in FIG. 8), the processing sections 101 to 112 other than the storage section 113 are the same as those in the first embodiment (the image processing apparatus shown in FIG. 1).

The image processing apparatus according to the second embodiment is characterized in that the image processing apparatus according to the first embodiment further includes the storage section 113 which stores the image signals processed by the color component control section 106 and in that the second segmentation section 108 performs the processing by reading the signals stored in the storage section 113.

In a copy job of copying a plurality of sheets or the like, the image processing apparatus is normally constituted to temporarily store the image data. However, according to the present invention, the black character segmentation information is buried in the image data. Therefore, there is no need to separately store the segmentation signal (i.e., there is no need to provide a segmentation signal storage section separately from the storage section 113 in the configuration shown in FIG. 8), thereby making it possible to save a memory capacity.

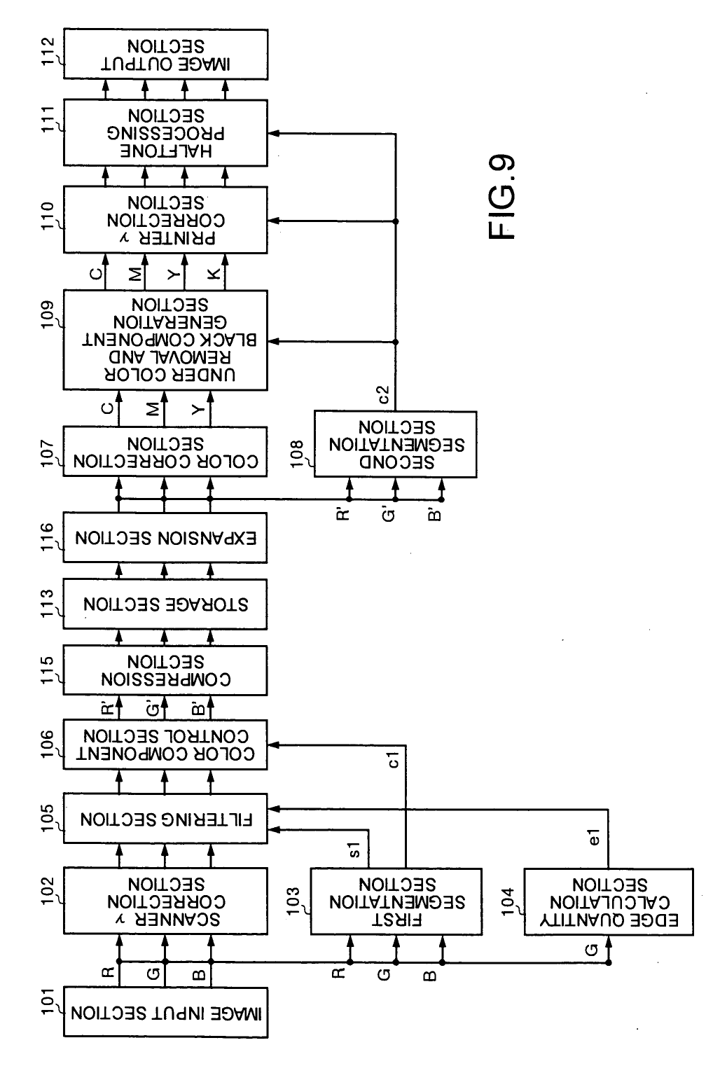

FIG. 9 illustrates an example of the configuration of an image processing apparatus according to a third embodiment of the present invention. This image processing apparatus has the same configuration as that shown in FIG. 1 except that a compression section 115 compresses the outputs of the color component control section 106, the storage section 113 (see FIG. 8) stores the compressed outputs, an expansion section 116 reads and expands the signals stored in the storage section 113, and the color correction section 107, the second segmentation section 108, and the following sections performs their processings. Namely, in the third embodiment (the image processing apparatus shown in FIG. 9), the processing sections 101 to 112 other than the compression section 115, the storage section 113, and the expansion section 116 are the same as those in the first embodiment (the image processing apparatus shown in FIG. 1).

The image processing apparatus according to the third embodiment is characterized in that the image processing apparatus according to the first embodiment further includes the compression section 115 which conducts a compression processing to the image signals processed by the color component control section 106, the storage section 113 which stores the image signals compressed by the compression section 115, and the expansion section 116 expands the image signals stored in the storage section 113, and in that the second segmentation section 108 processes the image signals expanded by the expansion section 116.

The compression section 115 may perform either a reversible compression processing or a nonreversible compression processing. It is preferable, however, to perform the nonreversible compression processing in light of the number of signals stored in the storage section 113 and a data transfer rate. If the nonreversible compression processing is performed, the black character information buried in the image data by the color component control section 106 and the chromatic color pixel generation processing performed to improve the re-extraction accuracy are adversely influenced or degraded by compression and expansion. In which degree the signal level change occurs depends on the compression processing method, filter characteristics, the type of the original or the like. The color component control section 106 needs to conduct color component control according to the compression processing method of the compression section 115 so that the second segmentation section 108 can sufficiently detect (re-extract) the black character information.

It is also preferable that the compression section 115 compresses the image signals after converting the signals to luminance and color difference signals. As explained above, by generating the achromatic colored character from the black character, the black character segmentation information is buried in the image data. Therefore, it is preferable that a change in color saturation component in the black character area by the compression and the expansion is as small as possible. If the image signals are converted to luminance and color difference signals such as YUV signals, the color saturation component in the black character area is zero and the black character area is less deteriorated by the compression and the expansion. With the configuration in which the RGB signals are compressed for each print, if some of the R, G, and B signals are changed by compression-caused deterioration, the achromatic color pixels are converted to chromatic color pixels. With the configuration in which the YUV signals are employed, even if the Y signal is changed, the pixels remain achromatic color pixels unless the U and V signals have no change. For this reason, the compression section 115 preferably compresses the image signals after converting the image signals to the luminance and color difference signals.

In the first, second, and third embodiments, the chromatic color generation processing performed by the color component control section 106 can increase the color components only when the color component of the target pixels is smaller than a predetermined value.

In FIG. 5, the color component control section 106 controls the image signals so that the non-black character pixels are converted to the chromatic color pixels. Although color saturation control cannot be visually recognized, it is preferable that the color component control section 106 does not change the color saturation of the character. Accordingly, in order to minimize color component-controlled areas, the chromatic color pixel generation processing of the color component control section 106 can increase the color components only when the color component of the processing target pixels is smaller than the predetermined value.

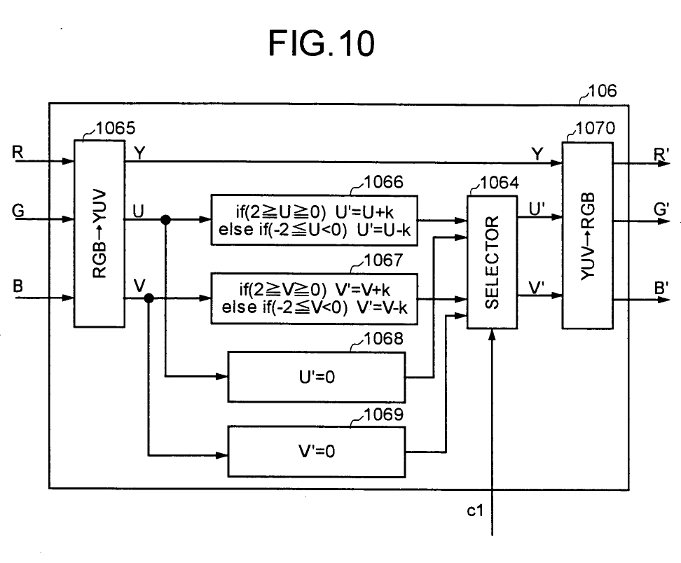

FIG. 10 illustrates an example of the configuration of the color component control section 106 which increases the color components only when the color component of the processing target pixels is smaller than the predetermined value. Namely, the color component control section 106 of FIG. 10 is constituted to increase the color component of the input non-black character pixels only when the color saturation component is smaller than the predetermined value. The block 1066 shown in FIG. 10, for example, controls the color saturation component to increase by k if an absolute value of the U component is equal to or smaller than two. The block 1066 does not perform any processing if the absolute value of the U component is greater than two. The block 1067 performs processings similarly to the block 1066. Namely, in the example of FIG. 10, since the pixel having sufficient color saturation is not erroneously detected (re-extracted) as a black character pixel, the block 1067 causes such a pixel to pass through the block 1067 and converts only the pixel close to the achromatic color pixel that may possibly be erroneously determined as a black character pixel to a chromatic color pixel. By doing so, it is possible to minimize the chromatic color pixel generation processing and ensure good color reproducibility.

For the same purpose as that explained with reference to FIG. 10, the color component control sections 106 in each of the first, second, and third embodiments can control the image signals to increase color components of an image area in which a probability of erroneously detecting (re-extracting) the non-black character pixels as black character pixels is high, as compared with the other regions or increase the color components only in the image area in which the probability of erroneously detecting (re-extracting) the non-black character pixels as black character pixels is high if the second segmentation section 108 detects (extracts) the black character pixels. It is thereby possible to minimize the color component control processing of the color component control section 106 conducted to the pixels other than the black character pixels.

Namely, the second segmentation section 108 shown in FIG. 3 detects (re-extracts) the black character information by detecting a lump R=G=B pixel lumps adjacent to the white pixels. With such a simple detection method, if a gray image is present on the white background, the pixels are often erroneously determined as black character pixels. A monochrome picture adhering onto a white sheet is a case in it. Even in the monochrome image, a lump of R=G=B pixels is hardly present. Besides, the second segmentation section 108 shown in FIG. 3 determines only the area having a three-dot width and adjacent to the white background as the black character area. This possible erroneous determination is substantially negligible. Nevertheless, it is preferable to avoid such erroneous determination so as to reproduce an image with a higher image quality.

To this end, according to the present invention, the image area which may possibly be erroneously determined by the later second segmentation section 108 is detected in advance, and only this detected image area is corrected so as not to be erroneously determined, thereby minimizing the areas subjected to the color component control.

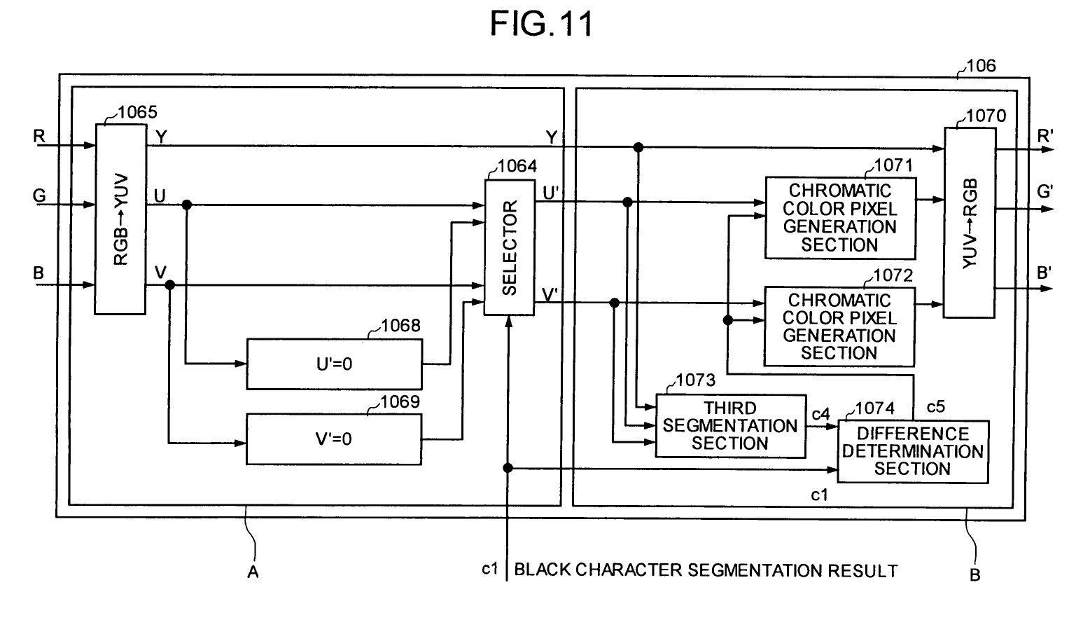

FIG. 11 illustrates an example of the configuration of the color component control section 106 which increases the color components in the image area in which the probability of erroneously detecting (extracting) the non-black character pixels as the black character pixels is high, as compared with the other areas or which increases the color components of the pixels only in the image area in which the probability of erroneously detecting (extracting) the non-black character pixels as the black character pixels is high. Namely, the color component control section 106 of FIG. 11 includes a section A that converts the black character pixels to achromatic color pixels and a section B that detects and corrects the image area which may possibly be erroneously determined by the later second segmentation section 108.

In the color component control section 106 of FIG. 11, the selector 1064 selects signals subjected to the achromatic color pixel generation processing for the black character pixels and inputs the selected signals to a third segmentation section 1073. The third segmentation section 1073 is equal in configuration to the second segmentation section 108 (see FIG. 3), i.e., constituted to detect a lump of achromatic color pixels on the white background. A black character segmentation result c4 detected by the third segmentation section. 107 is input to a difference determination section 1074. The difference determination section 1074 detects a difference of the black character segmentation result c4 from the original black character segmentation result c1 and also detects an image area that is erroneously determined as the black character area by outputting a signal c1. Chromatic color pixel generation sections 1071 and 1072 conduct chromatic color pixel generation processings to the erroneously determined image area indicated by the signal c5, respectively, and the block 1070 outputs the resultant signals.

In the third segmentation section 1073, a black character detection (re-extraction) parameter may be set as a parameter which can more facilitate detecting the black character. By so setting, the image area in which the frequency of the erroneous detection is increased by the degradation of the image caused by the compression and the expansion can be detected in advance.

As can be understood, the color component control section 106 of FIG. 11 converts the pixels in the area in which the probability of erroneously determining the non-black character pixels as the black character pixels is high in the later second segmentation section 108, to the chromatic color pixels. It is thereby possible to increase a margin for erroneous detection and minimize the areas subjected to the chromatic color pixel generation processing.

In the color component control section 106 of FIG. 11, the detection section having the same configuration as that of the second segmentation section 108 is employed as the third segmentation section 1073. Alternatively, if it is known that the probability of achromatic color pixels on the white background or the pixels close to the achromatic color pixels are erroneously detected is high similarly to the example of FIG. 11, the. image areas subjected to the chromatic color pixel generation processing can be specified in advance based on the white background area detection result from the first segmentation section 103, the black character detection result, and the information on the almost achromatic color pixels without providing the third segmentation section 1073.

A fourth embodiment of the present invention is characterized in that the image processing apparatus according to each of the first, second, and third embodiments has a processing function to convert the image signals subjected to the predetermined processing by the color component control section 106 to signals in a predetermined image format (a compression method, a compressibility, an image resolution, and a color space) designated by either the system or the user and transferring the format-converted signals to an external device, and in that the color component control section exercises control according to the designated, predetermined image format.

The control of the color component control section according to the designated, predetermined image format includes a control for expanding the black character pixel area determined by the first segmentation section 103 to surrounding areas as the area subjected to the achromatic color pixel generation processing.

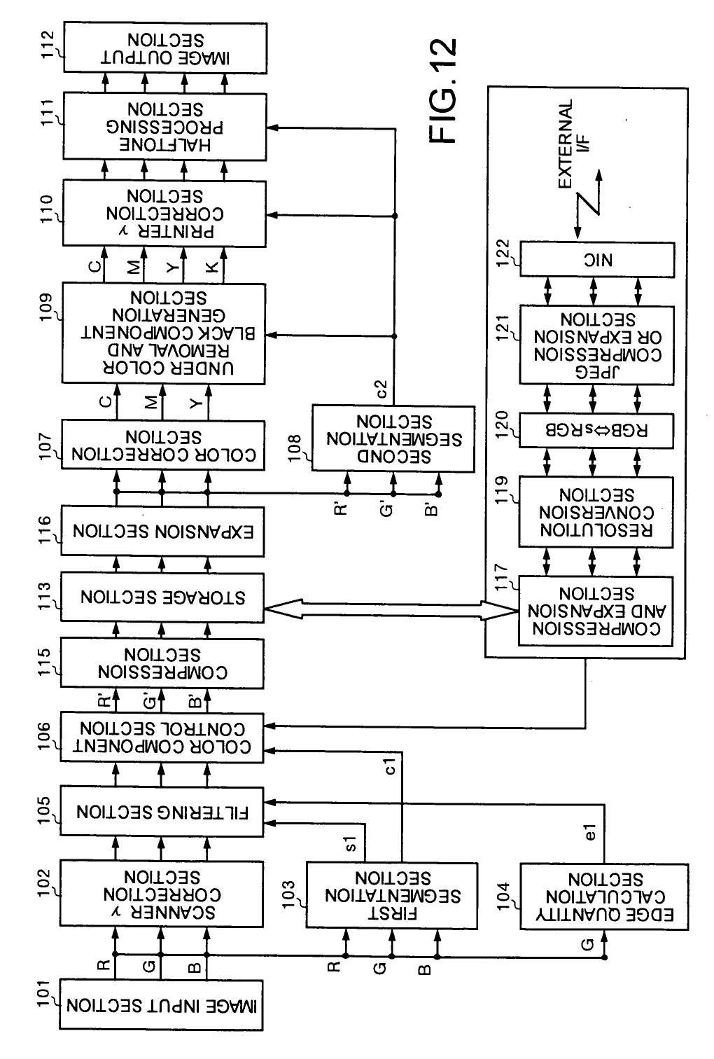

FIG. 12 illustrates an example of the configuration of an image processing apparatus according to the fourth embodiment of the present invention. In this image processing apparatus, the image signals stored in the storage section 113 are converted to signals in the predetermined format and the format-converted signals are transferred to the external device. Namely, in the image processing apparatus of FIG. 12, the signals from the storage section 113 are read and expanded by a compression and expansion section 117, and converted to signals having a predetermined resolution by a resolution conversion section 119. For purposes of reducing a data size at the time of transferring the signals to the external device, the resolution conversion section 119 converts the image signals having a resolution of, for example, 600 dots per inch to image signals having a resolution of 300 dots per inch or 200 dip. Further, a block 120 converts the signals to standard signals such as standard RGB (sRGB) signals, a joint photographic experts group (JPEG) compression and expansion section 121 converts the sRGB signals to signals in a JPEG format, and the resultant signals can be transferred to the external device through a network interface card (NIC) 122.

The image signals transferred to the external device are used as image data scanned by an application of a personal computer (PC) or input to the image processing apparatus again, reproduced and output. In the latter case, unnecessary parts such as punch holes present in the image read by editing software are removed or the image is edited to be stamped and the stamped image is output. In the latter case, the signals can be input to the image processing apparatus again through the NIC 122, subjected to JPEG expansion by the JPEG compression and expansion section 121, converted to device-dependent RGB signals by the block 120, converted to signals having the predetermined resolution (600 dots per inch) by the resolution conversion section 119, compressed by the compression and expansion section 117, and stored in the storage section 113. A system controller (not shown) controls processings performed by sections following the expansion section 116.

In FIG. 12, as for the black character segmentation information buried in the image data by the first color component control section 106, since the image data is degraded and changed by the resolution conversion section 119 and the JPEG compression and expansion section 121, the black character information detection (re-extraction) accuracy of the second segmentation section 108 at the time of duplicating and outputting the signals again is deteriorated.

The fourth embodiment is intended to satisfy the image quality of the black character even if the image signals are re-output after being subjected to the format conversion for transferring the signals to the external device. To this end, the first color component control section is controlled according to the image format designated when transferring the image signals to the external device. Specifically, the first color component control section 106 is controlled to control the color components of the black character pixels and the non-black character pixels so as to improve a detection margin at the time of re-detection (re-extraction).

For example, to conduct the chromatic color pixel generation processing to the non-black character pixels, the chromatic color pixel generation degree higher than that at which the first color component control section 106 conducts the chromatic color pixel generation processing is set to the target pixels and the signals are output.

As an alternative, the areas subjected to the achromatic color pixel generation processing may be expanded. For example, the signals are converted to luminance and color difference signals (YCbCr) by JPEG compression for each 8×8 block size, and the image signals are compressed by discrete cosine transform (DCT) conversion. Assuming that the JPEG compression is conducted to the black character pixels which are converted to achromatic color pixels, if the other pixel in the 8×8 block is a chromatic pixel, the black character pixels are converted to chromatic color pixels. Normally, the white background area is present around the pixels determined as black character pixels and no color pixels having high color saturation are present around them. Even on the white background, pixels having low color saturation are certainly present, which brings about the above problem. The problem is more conspicuous when the compressibility is set higher.

By contrast, if the pixels in the 8×8 block are all achromatic color pixels, CbCr components are zero when the signals are converted to the YCbCr signals and the achromatic color information can be stored without being deteriorated. Therefore, if it is known that the signals are subjected to the JPEG compression and output to the external device, it suffices to constitute the first color component control section 106 to control the chromatic color pixel generation processing and the achromatic color pixel generation processing conducted to the non-black character pixels in each compression target block according to the presence/absence of the black character pixels in the block and to correct all the other chromatic pixels to achromatic color pixels if the black character pixels are present in the block.

Further, since no color pixels having high color saturation are present around the black character pixels, the problem of degrading the image quality does not occur by converting all the pixels in the block to achromatic pixels. However, if the compression is conducted to the gains in a larger block size, the image degradation problem may possibly occur by the converting the chromatic color pixels to the achromatic color pixels. If so, the achromatic color pixel generation processing is not conducted to chromatic color pixels having sufficient color saturation but only to the pixels having relatively low color saturation in the block.

Furthermore, in the fourth embodiment, the pixels around the black character pixels are converted to the achromatic color pixels for each block. However, pixels not in each block but in each area expanded from the black character pixel area by a few pixels may be converted to the achromatic color pixels. In this case, the number of pixels to be expanded may be determined according to the converted data format. The same thing is true for the resolution. If the image data is converted to low resolution data, the black character information can be satisfactorily stored by setting an area subjected to the achromatic color pixel generation processing wide.

As can be understood, by controlling the first color component control section 106, the black character information can be accurately buried in the signals which have been converted to signals in the data format having different resolution, conversion method, and compression method, thereby making it possible to realize high quality when the signals are duplicated again. In this embodiment, the image processing apparatus duplicates the image signals again. Alternatively, the signals can be duplicated again by an external image processing apparatus or an image processing program capable of re-extracting the buried attribute information and realizing adaptive processings.

A fifth embodiment of the present invention is characterized in that the image processing apparatus according to each of the second and third embodiments includes a processing section which converts the image signals stored in the storage section 113 to signals in the predetermined format designated by the system or the user, and in that the processing section includes a second color component control section which conducts one of or both of the chromatic color pixel generation processing or the achromatic color pixel generation section again to the image signals stored in the storage section 113 and the processing section conducts one of or both of the chromatic color pixel generation processing or the achromatic color pixel generation section again to the image signals stored in the storage section 113 and transfers the resultant signals to the external device.

The second color component control section can conduct one of or both of the chromatic color pixel generation processing and the achromatic color pixel generation processing again to the image signals stored in the storage section 113 according to attribute information identified from the image signals stored in the storage section 113.

Alternatively, the second color component control section can conduct one of or both of the chromatic color pixel generation processing and the achromatic color pixel generation processing again to the image signals stored in the storage section 113 according to the attributes of the target pixels determined by the first segmentation section 103.

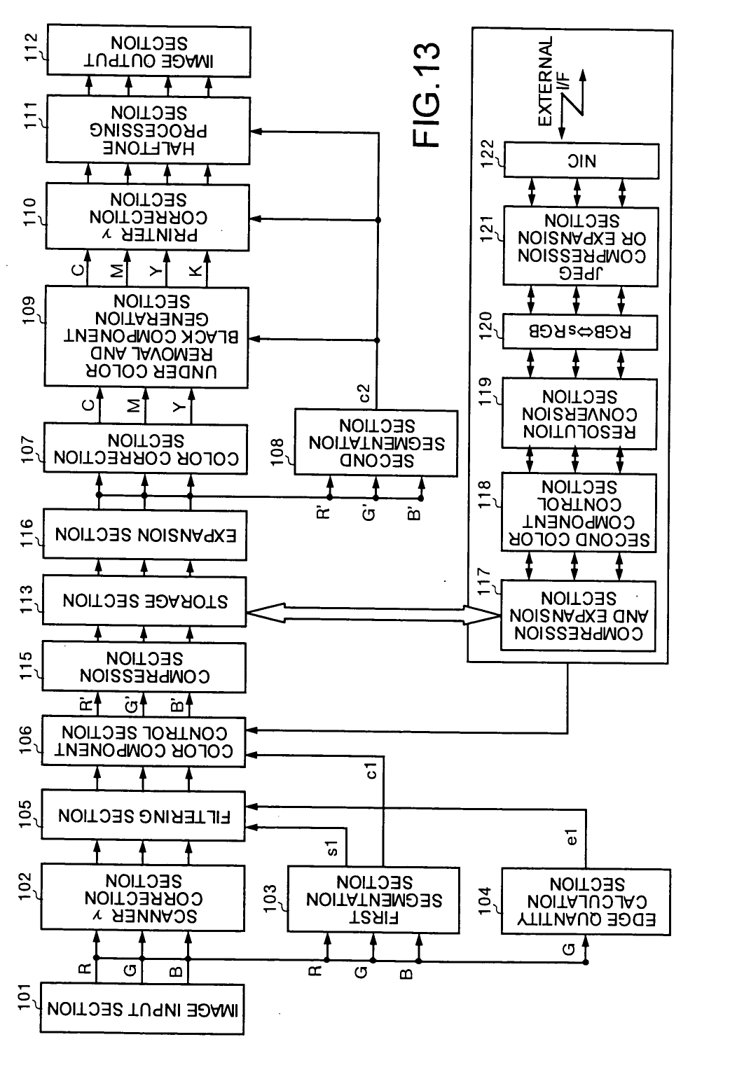

FIG. 13 illustrates an example of the configuration of an image processing apparatus according to the fifth embodiment. In the image processing apparatus of FIG. 13, the second color component control section 118 is further provided between the compression and expansion section 117 and the resolution conversion section 119 in the configuration shown in FIG. 12.

The configuration example of FIG. 13 is effective if the image data processed and stored by the storage section 113 for duplicating and outputting the image data is used to be output to the external device. Namely, the buried black character information optimized to be reproduced and output is deteriorated by the conversion of the resolution and the JPEG compression as explained above. However, if the achromatic color pixel generation processing is conducted in a wide range in light of the transfer of the image signals to the external device as explained in the fourth embodiment, the image degradation may occur to the image signals to be duplicated and output. In the fifth embodiment, therefore, the second color component control section 118 executes a black character information correction processing according to the data format in which the image data is transferred to the external device.

Specifically, the second color component control section 118 can conduct one of or both of the chromatic color pixel generation processing and the achromatic color pixel generation processing again to the image signals stored in the storage section 113 according to the attribute information identified from the image signals stored in the storage section 113.

Alternatively, the second color component control section 118 can conduct one of or both of the chromatic color pixel generation processing and the achromatic color pixel generation processing again to the image signals stored in the storage section 113 according to the attributes of the target pixels determined by the first segmentation section 103.

The control of the second color component segmentation section 118 may be conducted based on the black character segmentation result c1 from the first color component control section 103 or based on a re-extraction result obtained by re-extracting the black character information buried in the image data by a re-extraction section (not shown).

In each of the preceding embodiments, the storage section 113 can store designated output conditions and processing contents as well as the compressed image data. The storage of the designated output conditions and processing contents is effective if the stored image data is re-output later according to the designation of the output from an operation panel or the like. By reading information on the stored image data and recognizing an image quality mode (a character/photograph mode, a character mode, a photograph mode, or the like), an original type mode (a print sheet or a print original), filter parameters, parameters related to suppression of the color components or the like, the processing contents of the color correction section 1 07 and the halftone processing section 111 after the compression can be optimized.

It is also preferable that the contents of processings conducted to the image signals or the like can be output as header information or footer information. Specifically, information on the converted resolution, information indicating that the signals are sRGB signals, a JPEG quality, a processing content of the second color component control section, and the like can be added to the information and the resultant information can be output. By doing so (that is, by storing the content of the processing conducted to the image signals in the header information and transferring the resultant information when transferring the image signals to the external device), the image signals can be converted to signals in an appropriate image format according to the header information if the signals are input again from the external device.

The second segmentation section 108 can detect (extract) the black character with high accuracy by changing the segmentation method and the parameters based on the header information. For example, thresholds for the chromatic color pixel determination and the achromatic color pixel determination can be controlled according to the compressibility and the resolution. Specifically, if the compressibility is high, the probability of causing image degradation is high. Therefore, the determination thresholds are set generous so as to be able to detect the black character more easily. If the compressibility is further high, erroneous detection considerably increases when re-extracting the black character and the image quality of the pattern part is considerably degraded. Therefore, the achromatic color pixel determination is set stricter or the black character re-extraction function is turned off. By thus optimally controlling the second segmentation section according to the compressibility, it is possible to obtain a totally optimum image quality.

As for the resolution, if the image is temporarily converted to an image having a low resolution equal to or lower than a certain level, the black character can be often detected easily by turning off the black character re-extraction function. By thus optimally controlling the second segmentation section according to the compressibility, it is possible to obtain a totally optimum image quality.

If the color component change processing is performed by external editing, the black character re-extraction function can be similarly turned off.

Furthermore, if information on the burying of the black character information is not added to the image signals input from the external device of no header information is added to the black character information, the black character re-extraction function can be turned off.

In other words, the image processing apparatus, in which the second segmentation section 108 determines the attributes of the image data input from the external device, can control the black character extraction method for the second segmentation section 108 according to the header information.

In addition, the image processing apparatus, in which the image data input from the external device is stored in the storage section 113, the image signals stored in the storage section 113 are read to the second segmentation section 108, and the attributes of the target pixels are detected (extracted) by the second segmentation section 108 to thereby conduct the image processing to the image signals, can control the black character extraction of the second segmentation section 108 or control the second segmentation section 108 not to perform the black character extraction if the header information indicating the processing content is not added to the input image signals.

By thus controlling the second segmentation section 108 to be actuated or deactivated and controlling the parameters according to the information added to the image data, an optimum image quality among reproducible image qualities can be output.

As explained, according to the fifth embodiment, the image processing apparatus includes the first segmentation section which determines the attributes of the target pixels for the input color image signals, the color component control section which conducts the predetermined processing to the color components of the target pixels based on the attributes of the target pixels determined by the first. segmentation section, and the second segmentation section which determines the attributes of the target pixels for the image signals processed by the color component control section, and the color component control section conducts the predetermined processing to the color components of the target pixels so as to improve the target pixel attribute determination accuracy of the second segmentation section (i.e., the first segmentation section has the black character pixel determination function to determine whether the target pixels are black character pixels based on the attributes of the target pixels, the color component control section performs the chromatic color pixel generation processing for increasing the color components of the target pixels if the first segmentation section determines that the target pixels are not the black character pixels, and the second segmentation section has a function to detect (extract) the black character pixels by analyzing at least the color components of the image signals processed by the color component control section). It is thereby possible to detect (re-extract) the black character information with high accuracy as compared with the conventional image processing apparatus.

More specifically, the black character information buried. in the image data as R=G=B is deteriorated by the compression and the expansion and cannot be often, satisfactorily detected (re-extracted). The fifth embodiment provides the image processing apparatus having a high resistance against the deterioration of the pixel information to solve the disadvantage. Therefore, according to the fifth embodiment, not only the black character pixels are converted to achromatic color pixels but also the non-black character pixels are converted to chromatic color pixels. In addition, the area in which the erroneous segmentation may possibly occur when detecting (extracting) the black character information by the later processing or the sufficient chromatic color pixels are not subjected to the chromatic color pixel generation processing, whereby the chromatic color pixel processing is conducted only to the necessary pixels.

Furthermore, if a plurality of copies of the image data are produced or electronic sorting is conducted, the image data buried with the black character information is temporarily stored in a large-capacity storage section in a hard disk device or the like by as a plurality of pages and the stored image data is read. By enabling the configuration of the present invention in which the segmentation information is not stored as the data to be employed, the capacity of the storage section (storage unit) can be saved and the quantity of the data transferred to the bus can be reduced.

Furthermore, the image data is generally compressed and stored in the storage section (storage unit). If so, it is necessary to store the image data while preventing the deterioration of the black character information buried in the image data in advance as much as possible. According to the fifth embodiment, even if the data is changed by the nonreversible compression, a preprocessing is conducted to the data so as not to deteriorate the black character information.

If the image signals or the like stored in the storage section are transferred to the external device, the image signals are generally output after being further compressed by the other JPEG compression section or the like. Since the image signals are processed with different compression methods or different compressibility, the black character information buried in the image data is disadvantageously, often damaged. If so, the high quality reproduction of the image cannot be realized when the data transferred to the external device is re-input or transferred to and output from an MFP or the like including the other image processing system equal in configuration. According to the fifth embodiment, the image processing apparatus includes the second color component control section so as to be able to store the black character information even if the stored signals are further compressed by the other compression section and to be able to correct the black character code to turn the code into a firm state.

According to the fifth embodiment, by storing the content of the image processing conducted to the image data such as the image quality mode, the variable magnification, and the compressibility as the header information together with the image data, an optimum processing can be conducted when re-extracting the black character.

The embodiments have been explained on the presumption that the first segmentation section and the second segmentation section determine the black character on the white background as the black character area and determine that the black character on halftone dots as the non-black character area. However, the present invention is not limited to the embodiments.

Even if the first segmentation section determines the black character on the halftone dots or on the color background as the black character area, the pixels in the black character are changed to satisfy R=G=B to thereby bury the black character code in the image data. The second segmentation section extracts the pixels satisfying R=G=B and conducts the black character processing to the pixels. By doing so, the same advantage can be attained. The processing for converting the non-black character pixels to chromatic color pixels or the like is also advantageous to improve the segmentation accuracy of the second segmentation section and enable attaining the same advantage.

In the fifth embodiment, the image output section 112 is a printer. However, even if the image output section 112 is a device other than the printer, the present invention is applicable as long as the device has an image output function.

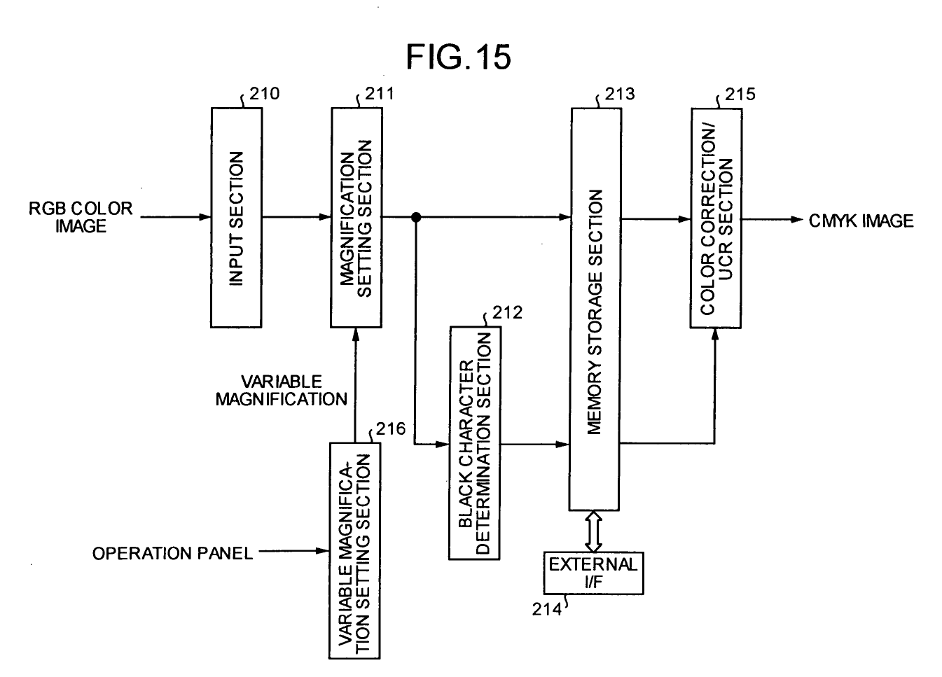

FIG. 15 is a block diagram of a color image processing apparatus according to a sixth embodiment of the present invention. This color image processing apparatus includes an input section 210, a magnification setting section 211, a black character determination section 212, a memory storage section 213, an external interface (hereinafter, “I/F”) 214, a color correction/UCR section 215, a variable magnification setting section 216, and the like.

If the magnification setting section 211 conducts a magnification setting processing to data on RGB color images acquired by a color scanner or the like, the user sets an arbitrary variable magnification to the variable magnification setting section 216 using the operation panel (not shown). The black character determination section 212 determines whether the image data subjected to the magnification setting processing by the magnification setting section 211 based on the variable magnification set to the variable magnification setting section 216 is black character area data. This black character determination is conventionally carried out by the segmentation or the like and the determination method is normally to comprehensively determine the black character based on a plurality of results of determinations including edge determination, the detection of the background such as the halftone dots, and the color determination. Since this determination method is well known, it will not be explained herein.

The image data thus subjected to the magnification setting processing and the black character determination result are stored in the memory storage section 213. If the data is compressed and stored therein, a memory capacity of the memory storage section 213 can be effectively used.

The image stored in the memory storage section 213 can be transmitted to the external device, not shown, through the external I/F 214 and image data can be received from the external data through the external I/F 214.

The color correction and UCR section 215 reads the image data and the black character determination result stored in the memory storage section 213, and reproduces the black character area to a single K color area or a substantially single K color area. If cyan-magenta-yellow-black (hereinafter, “CMYK”) images processed by the color correction and UCR section 215 are output to the printer or the like, not shown, the black color area is reproduced to the single K color area, whereby it is possible to suppress areas around the black character from being colored when out-of-color registration occurs and obtain a high quality output image.

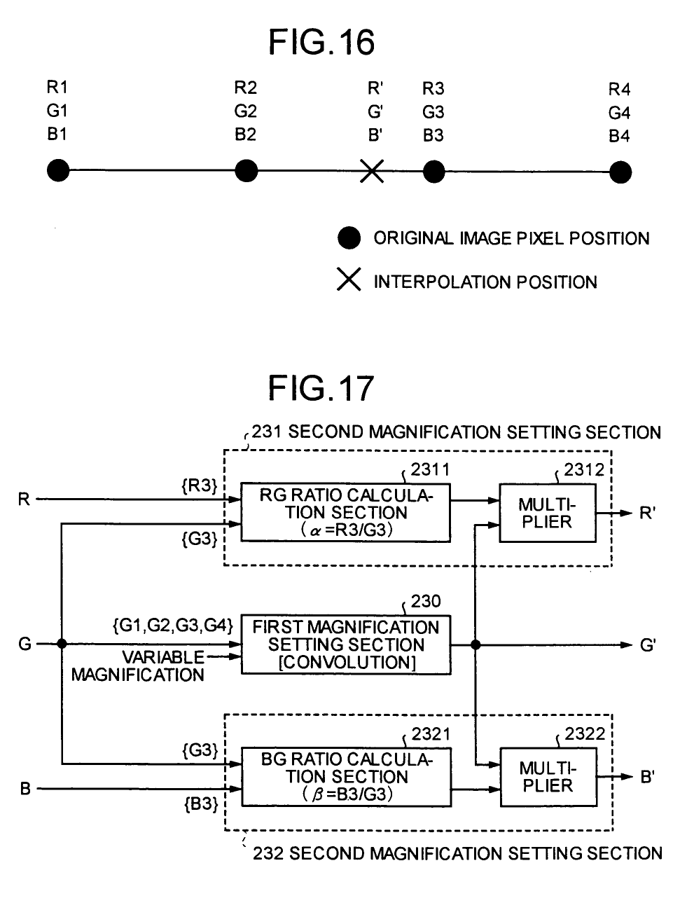

The detailed configuration of the magnification setting section 211 will be explained now. FIG. 16 illustrates the relationship between pixel positions of an original image and an interpolation position for the magnification setting section 211. Pixel data on the original image is represented by {Ri Gi Bi} (i=1, 2, 3, and 4) and interpolated pixels are represented by {R′, G′, B′}.

FIG. 17 is a block diagram of the magnification setting section 211. A magnification setting section includes a second magnification setting section 231 which conducts a magnification setting processing to the R signal, a first magnification setting section 230 which conducts a magnification setting processing to the G signal, and a second magnification setting section 232 which conducts a magnification setting processing to the B signal. The second magnification setting section 231 includes an RG ratio calculation section 2311 and a multiplier 2312. The second magnification setting section 232 includes a BG ratio calculation section 2321 and a multiplier 2322.

The operation of the magnification setting section shown in FIG. 17 for the G signal is equal to the conventional magnification setting processing. Namely, the first magnification setting section 230 conducts the magnification setting processing to the G signal using four adjacent pixels using the cubic convolution interpolation method.

The magnification setting processings to the R and B signals are, by contrast, different from the conventional magnification setting processing. Namely, the second magnification setting section 231 conducts the magnification setting processing so as to store an RGB ratio. The magnification setting processing to the R signal is as follows. The RG ratio calculation section 2311 in the second magnification setting section 231 calculates R3: G3 of the nearest neighbor pixels {R3, G3, B3} to the interpolation position to satisfy α=R3/G3. The multiplier 2312 in the second magnification setting section 231 multiplies α by G′ (which is data on the magnification-set G signal), thereby obtaining data on the magnification-set R signal as given by R′=α×G′. The magnification setting processing to the B signal is as follows. The BG ratio calculation section 2321 in the second magnification setting section 232 calculates B3: G3 of the nearest neighbor pixels {R3, G3, B3} to the interpolation position to satisfy β=B3/G3. The multiplier 2312 in the second magnification setting section 232 multiplies β by G′ (which is data on the magnification-set G signal), thereby obtaining data on the magnification-set B signal as given by B′=β×G′.

In the sixth embodiment, even after the magnification setting processing is conducted to the color image data, the RGB ratio is held. Therefore, even with the processing for color determination (e.g., black character determination) after the magnification setting, it is possible to realize highly accurate color determination. By storing the RGB ratio, in particular, the achromatic color to satisfy R=G=B=0 is stored without conducting any processing thereto and colors near the achromatic color are not converted to achromatic colors. Therefore, it is possible to realize achromatic color determination with less erroneous determination, which is quite advantageous for the achromatic color determination. Besides, for the magnification setting to the G signal, the cubic convolution interpolation method is used, so that the degradation of the image by the moire on the halftone dots can be advantageously decreased.

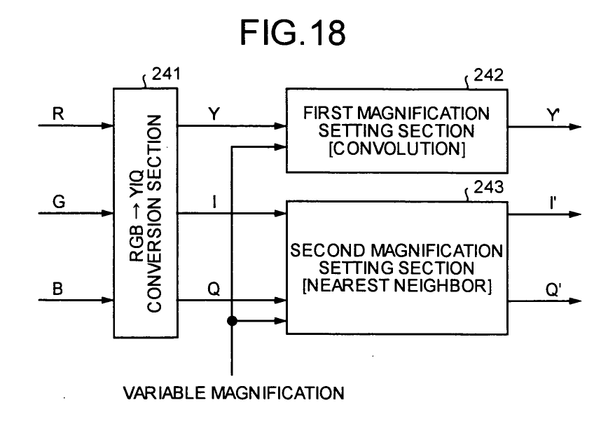

A seventh embodiment of the present invention relates to a configuration of the magnification setting section that is different from that in FIG. 17. FIG. 18 is a block diagram of the magnification setting section 211 according to the seventh embodiment. The magnification setting section 211 includes an RGB YIG conversion section 241, a first magnification setting section 242 serving as a luminance signal magnification setting unit, and a second magnification setting section 243 serving as a color difference signal magnification setting unit.

The RGB YIG conversion section 241 converts R (red), G (green), and B (blue) signals that are three components of color signals to YIQ signals that are luminance and color difference signals. A conversion equation for the RGB YIQ conversion section 241 is:

Y=0.30R+0.59G+0.11B I=0.60R−0.28G−0.32B Q=0.21R−0.52G−0.31B (6)

By calculating Y, I, and G signals according to the equation 6, the RGB signals can be converted to the YIQ signals.

In the seventh embodiment, the conversion of the RGB signals to the YIQ signals has been explained. Alternatively, the RGB signals may be converted to the other signals such as YCbCr signals, the other luminance and color difference signals, or lightness and chromaticity signals such as L*a*b*. Further, if the image represented by luminance and color difference signals is received through a network and the magnification setting processing is conducted to the received image, signal space conversion is often unnecessary.

The first magnification setting section 242 conducts a magnification setting processing to the Y (luminance) signal in the YIQ signals obtained by the previous RGB YIQ conversion section 241 by the cubic convolution interpolation method. The reason for using the cubic convolution interpolation method in the first magnification setting section 242 is to prevent moire occurring to the halftone dots due to the magnification setting processing (the luminance signal is a particularly large contribution to the moiré.)

The second magnification setting section 243 conducts a magnification setting processing to the IQ (color difference) signals in the YIQ signals obtained by the previous RGB YIQ conversion section 241 using the nearest neighbor interpolation method. The reason for using the nearest neighbor interpolation method in the second magnification setting section 243 is to hold color difference information.

The magnification methods are not limited to those explained above. The first magnification setting section 242 may use any magnification method as long as the method is to relatively widely refer to peripheral pixels and interpolate them. The second magnification setting section 243 may use any magnification method as long as the method is to refer to the peripheral pixels in a narrow range (adjacent pixels at most) and enable holding the color information without any influence of distant pixels. Supposing that the method referring to the same reference area between the first and the second magnification setting sections 242 and 243, e.g., the cubic convolution interpolation method is used, the sections 242 and 243 can conduct their respective magnification setting processings similarly to those explained above by setting parameters so that the influence of the nearer neighbor pixels on the second magnification setting section 243 is grater than that on the first magnification setting section 242.

According to the seventh embodiment, the color difference information is held even after the magnification setting. Therefore, even if the color determination is conducted after the magnification setting, it is possible to realize highly accurate color determination. The storage of the color difference information is greatly advantageous particularly to hold color information for not only achromatic color but all other colors and, therefore, advantageous for the determination of a specific color other than the achromatic color determination and the chromatic color determination. Besides, the magnification setting to the luminance signal which greatly contributes to moire is conducted by the cubic convolution interpolation method which has the effect of suppressing the moire. Therefore, the degradation of the image caused by the moiré at the halftone dots can be decreased.

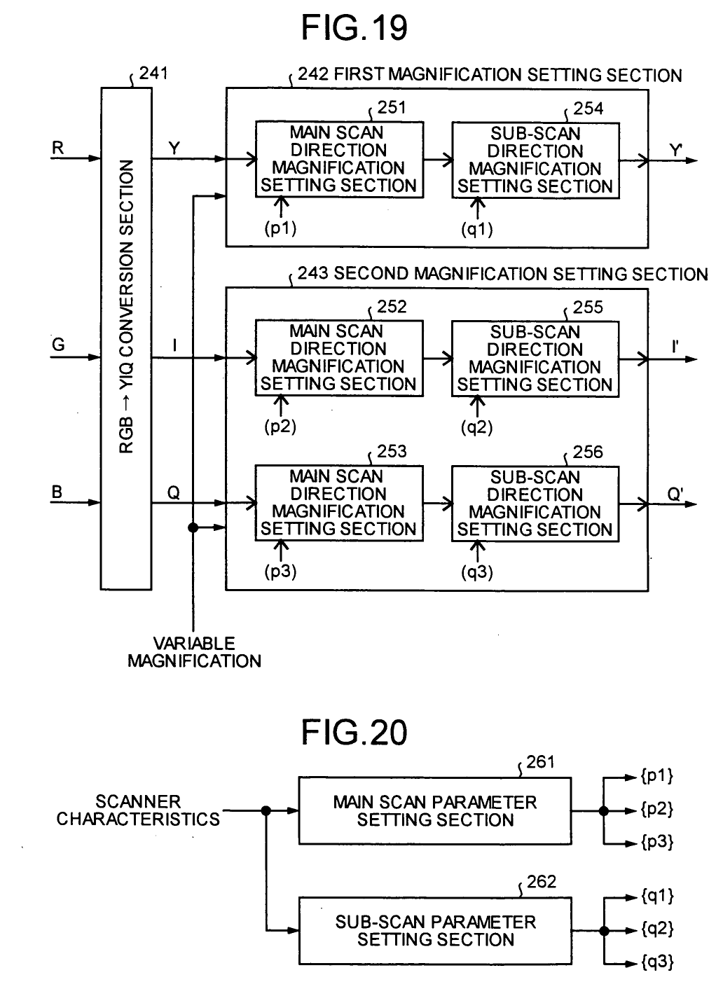

An eighth embodiment of the present invention relates to a color image processing apparatus which conducts electric magnification setting even for the magnification setting processing in the sub-scan direction. FIG. 19 is a block diagram of the magnification setting section in the eighth embodiment. This magnification setting section may be employed as the magnification setting section 211 of FIG. 15. This magnification setting section includes the RGB YIQ conversion section 241, the first magnification setting section 242, and the second magnification setting section 243. The first magnification setting section 242 includes a main scan direction magnification setting section 251 and a sub-scan direction magnification setting section 254. The second magnification setting section 243 includes main scan direction magnification setting sections 252 and 254, and sub-scan direction magnification setting sections 255 and 256.

The operation of the magnification setting section according to the eighth will be explained now. The RGB signals input to the RGB YIQ conversion section 241 are converted to YIQ signals. The main scan direction magnification setting section 251 and the sub-scan direction magnification setting section 254 in the first magnification setting section 242 conduct a magnification setting processing to the Y signal. The main scan direction magnification setting sections 252 and 253 and the sub-scan direction magnification setting sections 255 and 256 conduct magnification setting processings to the I and Q signals, respectively. The first magnification section 242 and the second magnification section 243 output magnification-set YIQ signals (Y′I′Q′ signals). The configuration of the magnification setting section 211, in which different magnification setting processings are conducted to the signals such that the first magnification setting section 242 is employed for the magnification setting processing to the Y signal and the second magnification setting section 243 is employed for the magnification setting processing to the I and Q signals, succeeds to the seventh embodiment (see FIG. 18). Differently from the seventh embodiment, however, the eighth embodiment is characterized by using different parameters between the magnification setting in the main scan direction and that in the sub-scan direction.

FIG. 20 illustrates the parameter setting section that separately sets the parameters used in the main scan direction magnification setting sections and the sub-scan direction magnification setting sections in the respective magnification setting sections 242 and 243 shown in FIG. 19. This parameter setting section includes a main scan parameter setting section 261 and a sub-scan parameter setting section 262. The parameter setting section separately sets the parameters for the main scan direction magnification setting and the sub-scan direction magnification setting according to scanner characteristics. The “scanner characteristic” means herein parameters such as out-of-color registration quantities and modulation transfer function (hereinafter, “MTF”) characteristics in the main scan direction and the sub-scan direction of the scanner when the scanner reads the image and they are acquired by manual input, automatic calculation or the like at the time of shipping the apparatus from a factory. The out-of-color registration quantities are of great relevance to the color determination accuracy and differ between the main scan direction and the sub-scan direction. Therefore, by controlling the magnification setting for holding the color information in accordance with the out-of-color registration quantities in the respective directions, it is possible to hold the color information more accurately.

Accordingly, parameters p1, p2, and p3 set by the main scan parameter setting section 261 shown in FIG. 20 are input to the main scan direction magnification setting sections 251, 252, and 253 of the first magnification setting section 242 and the second magnification setting section 243 shown in FIG. 19, respectively and the respective magnification setting sections conduct their magnification setting processings. Parameters q1, q2, and q3 set by the sub-scan parameter setting section 262 shown in FIG. 20 are input to the sub-scan direction magnification setting sections 254, 255, and 256 of the first magnification setting section 242 and the second magnification setting section 243 shown in FIG. 19, respectively and the respective magnification setting sections conduct their magnification setting processings.

According to the eighth embodiment, the magnification setting processings are separately conducted in the main scan direction and the sub-scan direction using the parameters set by the main scan parameter setting section 261. and the sub-scan parameter setting section 262 according to the scanner characteristics. Therefore, it is possible to adjust the color determination accuracies in the main scan direction and the sub-scan direction to be equal in the color determination processing after the magnification setting and thereby improve the image quality of the image.

In the eighth embodiment, the parameters are changed when the magnification setting processing in the main scan direction and that in the sub-scan direction are switched over, thereby conducting different magnification setting processings. Needless to say, the present invention is not limited to the embodiment and different magnification setting processings may be conducted by switching over the magnification setting method for the main scan direction and that for the sub-scan direction.

In the eighth embodiment, the magnification setting section 211 has been explained based on the magnification setting processing in the YIQ space in the seventh embodiment. Alternatively, by using the other magnification setting method, the magnification setting processing in the main scan direction and that in the sub-scan direction can be switched over. Even if using the other magnification setting method, the same suitable advantages can be attained.

A ninth embodiment of the present invention relates to a magnification setting processing to an image in which code information is buried.

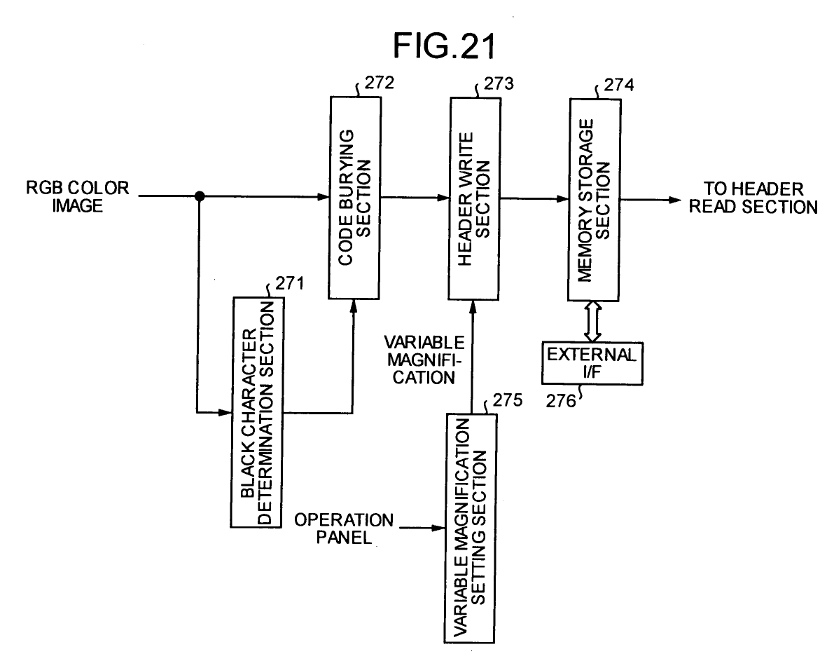

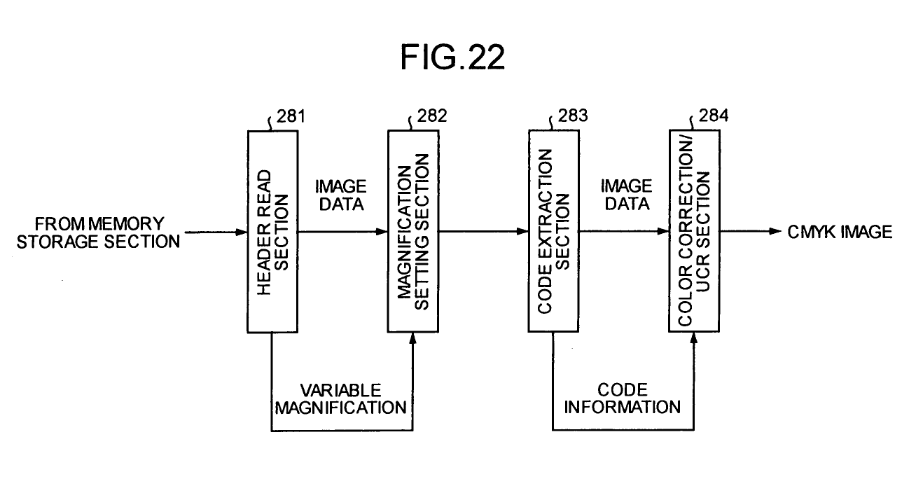

FIG. 21 illustrates a configuration that buries code information in an RGB color image in the ninth embodiment. FIG. 22 is an explanatory view for constituent sections that conduct the magnification setting processing to the image in FIG. 21 in which the code information is buried. The relationship between FIGS. 21 and 22 is that the sections shown in FIG. 21 are first half sections and those shown in FIG. 22 are second half sections in the same apparatus. Namely, FIG. 21 illustrates processings performed until the scanner input (RGB color image) is stored in a memory storage section 274. FIG. 22 illustrates processings until the color image stored in the memory storage section 274 is subjected to a magnification setting processing and output to the printer. However, the present invention is not limited to this example of relationship. For example, the sections shown in FIGS. 21 and 22 may not be the constituent sections of the same apparatus but may be transmission-side sections and reception-side sections connected to each other through a network. Further, it is possible to assume that the constituent sections shown in FIG. 22 acquire the image in which the code information is buried through an external I/F 276 shown in FIG. 21.

The operation of the color image processing apparatus according to the ninth embodiment will now be explained. As shown in FIG. 21, the RGB color image read by the scanner (not shown) is input to a code burying section 272 and a black character determination section 271. The black character determination section 271 conducts a processing for determining the black character area and the code burying section 272 buries the code information representing that this area is a black character in the black character area of the image. In the ninth embodiment, the color image processing apparatus uses the R=G=B as the code information similarly to the apparatus disclosed in Japanese Patent Application Laid-Open No. H8-98016. Needless to say, code information other than the R=G=B information can be used, as explained.

If the user sets an arbitrary variable magnification to a variable magnification setting section 275 through the operation panel, not shown, the variable magnification thus set is fed to a header write section 273, written as header information on the image in which the code information is buried, and stored in the memory storage section 274. This memory storage section 274 can transmit and receive the image data in which the code information is buried to and from the external device, not shown, through the external I/F 276.

As shown in FIG. 22, if a header read section 281 acquires the image data in which the code information is buried from the memory storage section 274 shown in FIG. 21, the header read section 281 refers to the header information. Since the variable magnification set by the user is written to the header, the magnification setting section 282 conducts a magnification setting processing based on the variable magnification acquired by the header read section 81. The image data which has been subjected to the magnification setting processing by the magnification setting section 282 is subjected to a code information extraction processing by a code extraction section 283 following the magnification setting section 282. As a result, a black character area discrimination signal is generated. Further, a color correction and UCR section 284 following the code extraction section 283 conducts a color correction processing to the image data based on the code information (the black character area discrimination signal) from the code extraction section 283, and outputs a CMYK image with the black character area reproduced by a single K color or substantially single color K.

In the code extraction processing of the code extraction section 283, the R=G=B information is used as the code information. Therefore, the code extraction processing is performed based on the detection result of R=G=B pixels as a matter of course. If the magnification setting method used in the sixth and second embodiments, the R=G=B data buried as the code information is held even after the magnification setting processing, so that highly accurate code extraction can be realized.

According to the ninth embodiment, the code information buried in a region having a predetermined feature such as a black character area of the image can be held even after the magnification setting. It is, therefore, possible to highly accurately perform the adaptive image processing using the code information in the later section.

A tenth embodiment of the present invention relates to another example of the magnification setting processing to the image in which the code information is buried differently from the ninth embodiment.

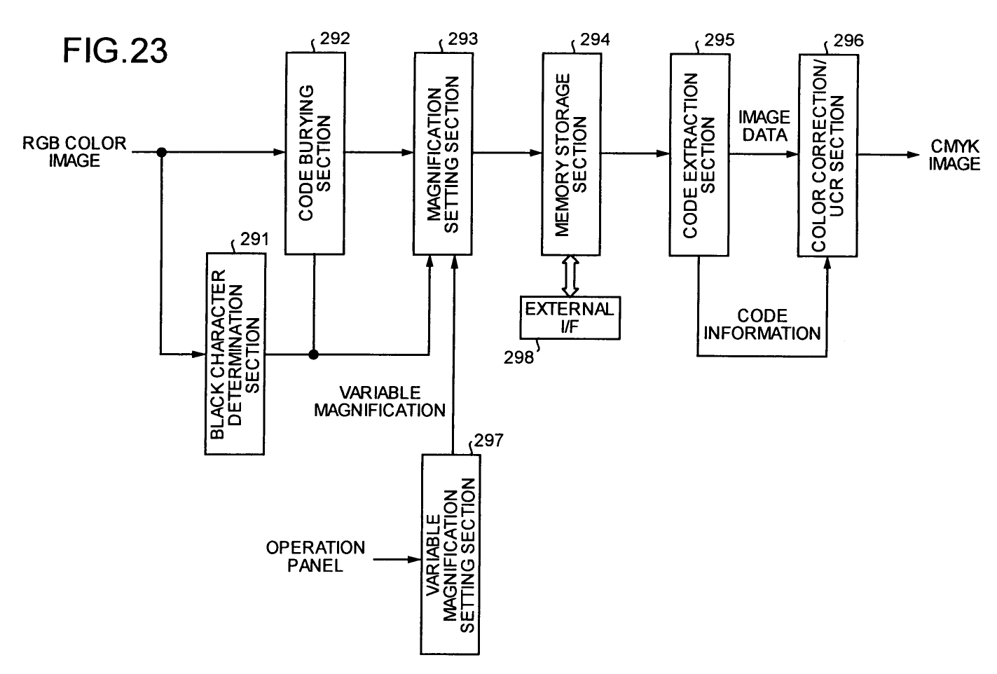

FIG. 23 is a block diagram of a color image processing apparatus according to the tenth embodiment. The configuration shown in FIG. 23 seems like a combination of the configurations shown in FIGS. 21 and 22 in relation to the ninth embodiment. However, the configuration shown in FIG. 23 differs from those shown in FIGS. 21 and 22 as follows. In the ninth embodiment, the magnification setting processing is conducted in the latter part (see the magnification setting section 282 shown in FIG. 22). In the tenth embodiment, the magnification setting processing is conducted in the former part (before a memory storage section 294).

In the tenth embodiment, by constituting the color image processing apparatus as shown in FIG. 23, the black character discrimination signal for code burying output from the black character determination section 291 can be referred to when a magnification setting section 293 conducts the magnification setting processing. Therefore, as compared with an instance in which the black character determination signal is input after the memory storage section 294, a load on the apparatus can be considerably reduced. To this end, the magnification setting section 293 refers to the black character area, and determines whether the nearest neighbor pixels to the interpolation position are pixels determined as black character pixels. If the nearest neighbor pixels are pixels determined as black character pixels, the magnification setting section 293 interpolates the pixels each having the code information representing that the pixel is a black character pixel as magnification-set pixels. In FIG. 23, the code burying section 292 and the magnification setting section 293 are provided as different blocks and the sections 292 and 293 sequentially conduct serial processings. However, the present invention is not limited to this configuration and the apparatus can be constituted to simultaneously execute the magnification setting processing and the code burying processing.

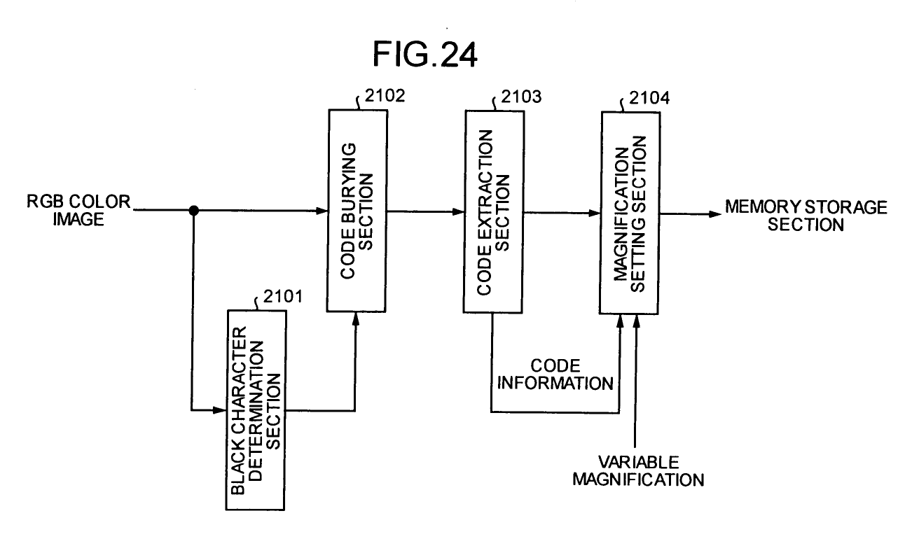

FIG. 24 is a block diagram another example of the configuration of the color image processing apparatus according to the tenth embodiment. As shown in FIG. 24, the apparatus can be constituted so that a code extraction section 2103 following a code burying section 2102 extracts the code information buried in the image data by the code burying section 2102, without directly referring to the black character determination signal by a magnification setting section 2104, so that the magnification setting processing is conducted for the RGB color image while referring to the extracted code information.

By adopting the configuration shown in FIG. 24, advantages are considered to be attained in the following instance. If the processing is realized by the hardware configuration, the code burying section 2102 and the code extraction section 2103 are not provided on the same substrate. If so, the code extraction is more advantageous to the hardware than the direct input of the black character determination signal to the magnification setting section.

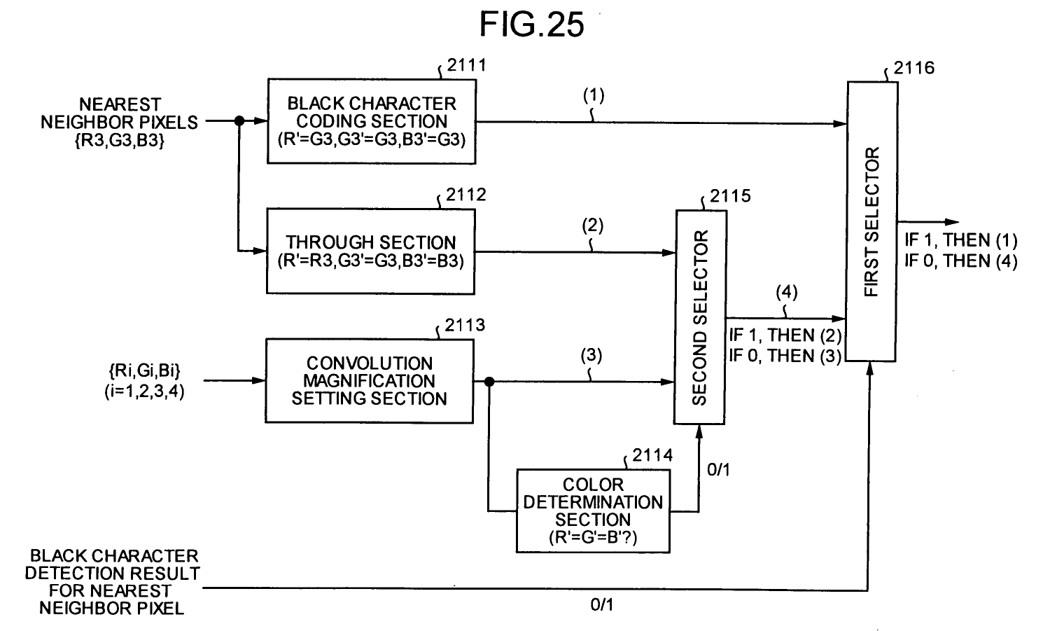

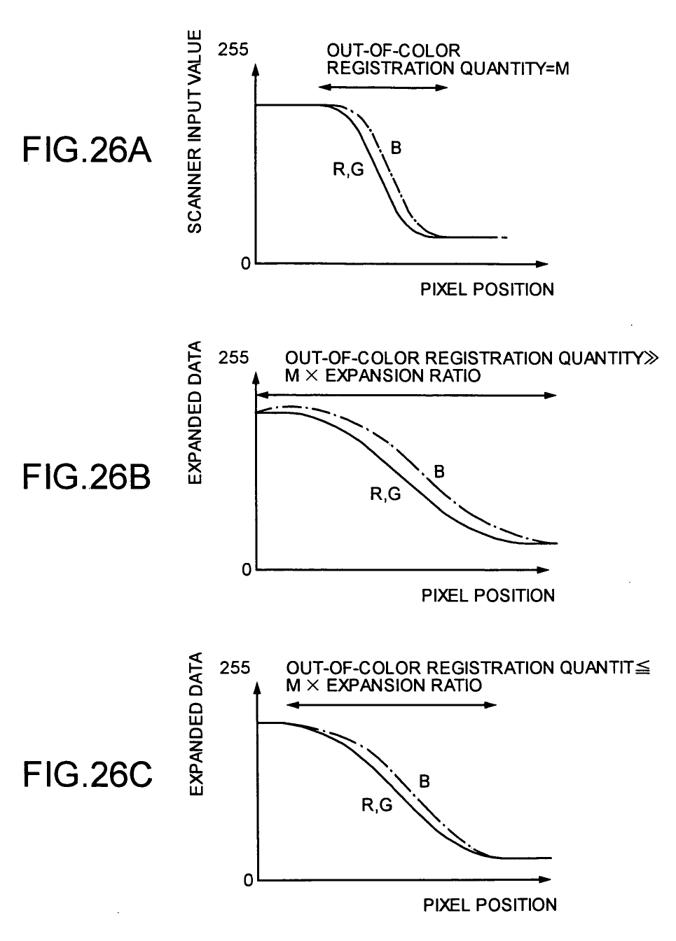

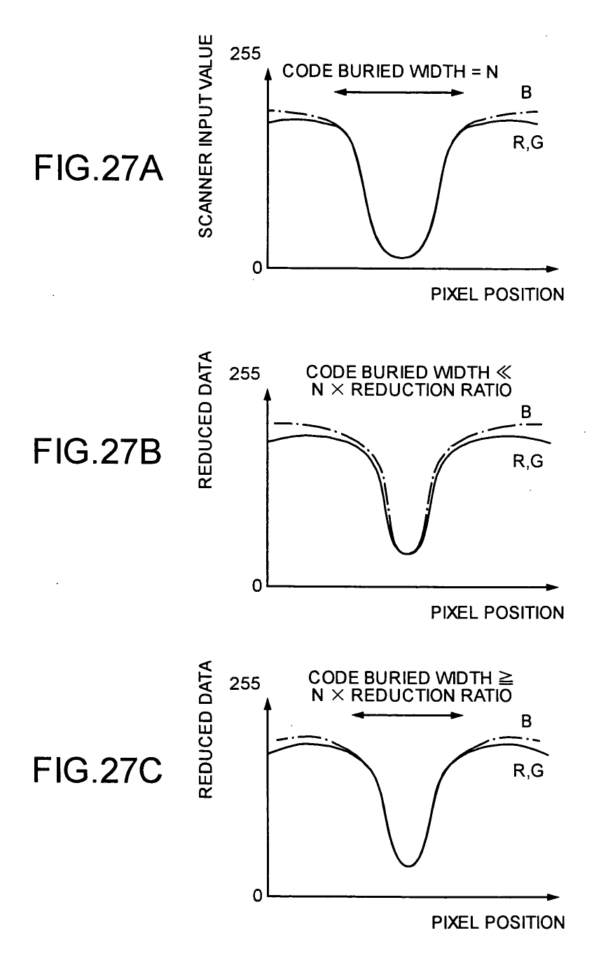

FIG. 25 is a block diagram of yet another example of the configuration of the color image processing apparatus according to the tenth embodiment. The apparatus includes a black character coding section 2111, a through section 2112, a convolution magnification setting section 2113, a color determination section 2114, a second selector 2115, a first selector 2116, and the like. If the magnification setting processing is conducted in the configuration as shown in FIG. 25, it is possible to further improve accuracy for the code extraction performed after the magnification setting processing.

The operation of the apparatus constituted as shown in FIG. 25 will be explained. If it is determined that the nearest neighbor pixels are black character pixels (an input of the first selector 2116 is “1”) by referring to the black character detection result for the nearest neighbor pixels, the first selector 2116 selectively outputs the pixels having black character code information output from the black character coding section 2111 and stores the selected pixels as magnification-set pixels.

If it is determined that the nearest neighbor pixels are non-black character pixels (the input of the first selector 2116 is “0”) by referring to the black character detection result, outputs of the convolution magnification setting section 2113 are basically interpolated as magnification-set pixels. However, only if the values obtained by the cubic convolution interpolation operation satisfy the R=G=B information which is the code information indicating that the pixels are black character pixels (the color determination section 2114 determines “1”), the second selector 2115 selects the nearest neighbor pixels output from the through section 2112 as the interpolated pixels. This can prevent the non-black character pixels from being converted to the pixels satisfying R=G=B and having the code information. Accordingly, it is advantageously possible to suppress the erroneous extraction of the non-black character area pixels as black character area pixels in the code extraction following the magnification setting.

According to the tenth embodiment, by inputting the black character determination signal or the code information extracted by the code extraction processing to the magnification setting processing, the code information buried in the area having the predetermined feature such as the black character area of the image is held even after the magnification setting. It is, therefore, possible to highly accurately execute the adaptive image processing using the code information in the later section.

In the embodiments explained above, the apparatus has been explained assuming that the code information is a*=b*=0. However, the present invention is not limited to the embodiments and the other color information may be buried in the image data.

In all the embodiments, if the code information of a*=b*=0 is buried in the image data and many pixels satisfying a*=b*=0 are inherently present in the non-black character area, then the pixels satisfying a*=b*=0 in the non-black character area are extracted as part of black character area pixels in the code extraction, and it is difficult to separate the pixels in the non-black character area and those in the black character area. To avoid this disadvantage, color information having a lower occurrence probability than a*=b*=0 can be used as the code information buried in the scanner input signals. For example, R=B=0 is buried as the code information, the G signal is used for the area extracted as the black character area in the later section, and the black character image is reproduced. By doing so, differently from the instance in which the a*=b*=0 is buried as the code information, if the code information-buried image is viewed as it is, the user feel strange about the image; however, the code information-buried image is often advantageous for the improvement of the code extraction accuracy.

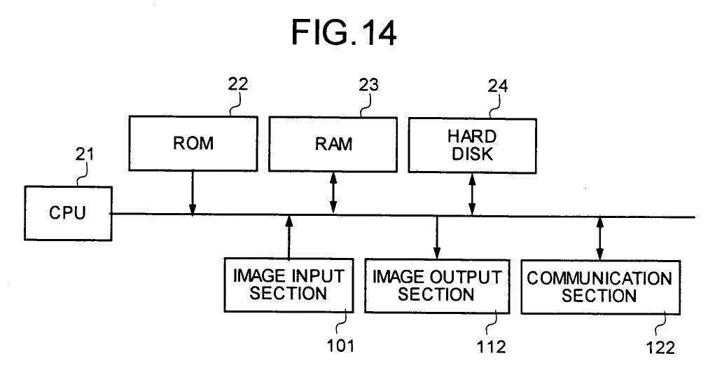

FIG. 14 illustrates an example of the hardware configuration of the image processing apparatus according to the present invention. This image processing apparatus is, for example, a PC. The image processing apparatus includes a central processing unit (CPU) 21 which controls the entirety of the apparatus, a read only memory (ROM) 22 which stores a control program or the like for the CPU 21, a random access memory (RAM) 23 which is used as a work area or the like of the CPU 21, a hard disk 24, an image input section 101 such as a scanner, an image output section 112 such as a disk player or a printer, and a communication section 122 such as the NIC.

The hard disk 24 corresponds to the storage section 113. The CPU 21 performs the functions of the units provided with the reference numerals 102, 103, 104, 105, 106, 107, 108, 109, 110, 111, 115, 116, 117, 118, 119, 120, 121, 211, 212, 213, 215, 216, 230, 231, 232, 241, 242, 243, 251, 252, 253, 254, 255, 256, 261, 262, 271, 272, 273, 274, 275, 281, 282, 283, 284, 291, 292, 293, 294, 295, 296, 297, and the like.

The functions of the CPU 21 as the units provided with the reference numerals 102, 103, 104, 105, 106, 107, 108, 109, 110, 111, 115, 116, 117, 118, 119, 120, 121, 211, 212, 213, 215, 216, 230, 231, 232, 241, 242, 243, 251, 252, 253, 254, 255, 256, 261, 262, 271, 272, 273, 274, 275, 281, 282, 283, 284, 291, 292, 293, 294, 295, 296, 297, and the like can be provided as, for example, a software package (i.e., an information recording medium such as a CD-ROM).

According to the present invention, the processings of the units provided with the reference numerals 102, 103, 104, 105, 106, 107, 108, 109, 110, 111, 115, 116, 117, 118, 119, 120, 121, 211, 212, 213, 215, 216, 230, 231, 232, 241, 242, 243, 251, 252, 253, 254, 255, 256, 261, 262, 271, 272, 273, 274, 275, 281, 282, 283, 284, 291, 292, 293, 294, 295, 296, 297, and the like can be provided as a program realized by the computer (CPU 21).

In other words, the image processing apparatus according to the present invention can be realized in the configuration in which a general-purpose calculator system including a scanner, a printer or the like reads the program recorded on the recording medium such as the CD-ROM and a microprocessor of this general-purpose calculator system executes the processings. The program for executing the processings of the present invention (i.e., the program used in the hardware system) is provided while being recorded on the recording medium. The recording medium which records the program or the like is not limited to the CD-ROM but a ROM, a RAM, a flexible disk, a memory card or the like may be used as the recording medium. The program recorded on the medium is installed to the storage device incorporated into the hardware system, e.g., the hard disk 24 and started, whereby this program can be executed and the processings of the present invention can be realized.

In the embodiments, the present invention has been explained as the image processing apparatus. However, if the sections executing the respective functions are mutually connected by the network, a person having ordinary skill in the art can regard the present invention as an image processing system and further an image processing method.

In the embodiments, the processings of the present invention are realized by the hardware configuration. Needless to say, the processings can be realized as software.

In the embodiments, the present invention has been explained while referring to the examples on the assumption of the color printer. However, the present invention is also applicable to the other device that performs the color image processing such as a color copying machine or a color facsimile machine.

As explained so far, according to a first aspect of the present invention, the image processing apparatus includes a first segmentation unit that determines attributes of a target pixel for input color image signals, a color component control unit that conducts a predetermined processing to color components of the target pixel based on the attributes of the target pixels determined by the first segmentation unit, and a second segmentation unit that re-determines the attributes of the target pixel determined by the first segmentation unit for the color image signals processed by the first color component unit. The color component control unit conducts the predetermined processing so as to improve the target pixel attribute determination accuracy of the second segmentation unit, whereby the black character information can be detected (re-extracted) with high accuracy as compared with the conventional apparatus.

Specifically, for example, the color component control unit suppresses the color components of the pixels in the black character area or completely converts the pixels in the black character area to achromatic color pixels and conducts the processing for increasing color saturation components of the pixels to the pixels in the non-black character area according to the black character segmentation result. It is thereby possible to detect (re-extract) the black character information with high accuracy as compared with the conventional apparatus. Further, the image processing apparatus is constituted to store the black character segmentation information in the image data and allow the second segmentation unit following the color component control unit to detect (re-extract) the black character information according to the color saturation information. Therefore, it is possible to highly accurately re-extract the black character at a large margin for a change in pixel value caused by the compression or the like. In addition, the method of converting the pixels in the non-character area to chromatic color pixels and the method of converting the pixels in the colored character area to chromatic color pixels enable widening a margin at the time of the re-extraction.

The chromatic color pixel generation processing is not conducted to the area which may possibly cause erroneous segmentation at the time of detecting (extracting) the black character information by the later section and sufficient chromatic color pixels. Thus, by minimizing the pixel areas in which the chromatic color pixel generation processing is conducted to only the necessary pixels (only the necessary pixels are converted to the chromatic color pixels), an original color can be stored in almost all areas of the image.

Furthermore, the image data is generally compressed and then stored in the storage unit. However, by converting the image signals to luminance and color difference signals and then compressing the signals, the black character information buried in the image data in advance can be stored while preventing the black character information from being deteriorated as much as possible.

If the image signals or the like stored in the storage unit are transferred to the external device, the image signals are generally output after being further compressed by the other JPEG compression unit or the like. Since the image signals are processed with different compression methods or different compressibilities, the black character information buried in the image data is often damaged. If so, the high quality reproduction of the image cannot be realized when the data transferred to the external device is re-input or transferred to and output from an MFP or the like including the other image processing system equal in configuration. According to the present invention, by contrast, the second color component control unit corrects the black character information to turn into a firm state even if the stored signals are further compressed by the other compression unit and output.

Furthermore, by storing the content of the image processing conducted to the image data such as the image quality mode, the variable magnification, and the compressibility as the header information or the like together with the image data when storing the image data and by conducting the optimum processing using the information when re-outputting the image data, the black character can be optimally detected (re-extracted) and the high quality image can be re-output.

According to a second aspect of the present invention, the magnification setting unit allows the color image signals which have been subjected to the magnification setting processing to hold predetermined color information if conducting the magnification setting processing to the color image signals. Therefore, even if the color determination is conducted after the magnification setting processing, it is possible to realize highly accurate color determination.

According to a third aspect of the present invention, the image processing apparatus includes the magnification setting unit that conducts the magnification setting processing to the color image signals in which the code information representing the feature of the image is buried and the code information is held even after the magnification setting unit conducts the magnification setting processing. Therefore, if the code information is extracted after the magnification setting processing, it is possible to realize highly accurate code information extraction.

According to a fourth aspect of the present invention, at the magnification setting step, the magnification setting processing is conducted to the color image signals and the magnification setting step is executed so as to allow the color image signals which have been subjected to the magnification setting processing to hold predetermined color information. Therefore, even if the color determination is conducted after the magnification setting processing, it is possible to realize highly accurate color determination.

According to a fifth aspect of the present invention, the image processing method includes the magnification setting step of conducting the magnification setting processing to the color image signals in which the code information representing the feature of the image is buried and the code information is held even after the magnification setting processing at the magnification setting step. Therefore, if the code information is extracted after the magnification setting processing, it is possible to realize highly accurate code information extraction.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. An image processing apparatus comprising:
an input unit that inputs color image signals;
a first segmentation unit that determines attributes of a target pixel for the color image signals;
a color component control unit that conducts a predetermined processing to color components of the target pixel based on the attributes of the target pixels determined to thereby generate processed color image signals;
a second segmentation unit that determines attributes of the target pixel for the processed color image signals; and
an image processing unit that conducts an image processing to the processed color image signals based on the attributes of the target pixel determined by the second segmentation unit.

2. The image processing apparatus according to claim 1, wherein
the first segmentation unit determines whether the target pixel is any one of a black character pixel and a non-black character pixel based on the attributes of the target pixel,
the color component control section increases the color components of the target pixel upon the first segmentation unit determining that the target pixel is the non-black character pixel,
the second segmentation unit detects a black character pixel by analyzing at least color components of the processed color image signals, and
the image processing unit conducts the image processing to the processed color image signals based on the black character pixel detected.

3. The image processing apparatus according to claim 2, wherein
the color component control unit performs an achromatic color pixel generation processing for any one of reducing and removing the color components of the target pixel that is determined by the first segmentation unit to be the black character pixel.

4. The image processing apparatus according to claim 1, wherein
the first segmentation unit determines whether the target pixel is any one of a colored character pixel and a non-colored character pixel based on the attributes of the target pixel,
the color component control section increases the color components of the target pixel upon the first segmentation unit determining that the target pixel is the non-colored character pixel,
the second segmentation unit detects a colored character pixel by analyzing at least color components of the processed color image signals, and
the image processing unit conducts the image processing to the processed color image signals based on the colored character pixel detected.

5. The image processing apparatus according to claim 1, wherein
the first segmentation unit determines whether the target pixel is any one of a character pixel and a non-character pixel based on the attributes of the target pixel,
the color component control section increases the color components of the target pixel upon the first segmentation unit determining that the target pixel is the non-character pixel,
the second segmentation unit detects a character pixel by analyzing at least color components of the processed color image signals, and
the image processing unit conducts the image processing to the processed color image signals based on the character pixel detected.

6. The image processing apparatus according to claim 1, further comprising a storage unit that stores the processed color image signals, wherein
the second segmentation unit determines the attributes of the target pixel based on the processed color image signals stored in the storage unit.

7. The image processing apparatus according to claim 1, further comprising:
a compression unit that compresses the processed color image signals to thereby generate compressed processed color image signals;
a storage unit that stores the compressed processed color image signals; and
an expansion unit that expands the compressed processed color image signals stored in the storage unit to thereby generate expanded processed color image signals, wherein
the second segmentation unit determines the attributes of the target pixel based on the expanded processed color image signals stored in the storage unit.

8. The image processing apparatus according to claim 7, wherein
the compression unit conducts a nonreversible compression processing to the processed color image signals.

9. The image processing apparatus according to claim 7, wherein
the compression unit converts the processed color image signals to luminance and color difference signals and then compresses the processed color image signals.

10. The image processing apparatus according to claim 2, wherein
the color component control unit increases the color components upon the color components of the target pixel, attributes of which are determined, being smaller than a predetermined value.

11. The image processing apparatus according to claim 2, wherein
the color component control unit increases the color components for an image area in which a probability of erroneously detecting the non-black character pixel as the black character pixel is high when the second segmentation unit detects the black character pixel than other areas or for increasing the color components only of the image area in which the probability of erroneously detecting the non-black character pixel as the black character pixel is high.

12. The image processing apparatus according to claim 1, wherein
the first segmentation unit determines any one of a black character pixel on a white background area and a black line pixel on a white background area as a black character pixel, and
the second segmentation unit determines a pixel, which is in an area adjacent to a white pixel area and which is substantially an achromatic color pixel, as a black character pixel.

13. The image processing apparatus according to claim 1, further comprising:
a conversion and transfer unit that
converts the processed color image signals into image signals in a predetermined image format that is designated by one of a system and a user,
transfers the image signals in the predetermined image format to an external device, and
controls the color component control unit according to the predetermined image format.

14. The image processing apparatus according to claim 13, wherein
the conversion and transfer unit controls an area of the black character pixel determined by the first segmentation unit to be expanded, as the area subjected to an achromatic color pixel generation processing, to a surrounding area as control over the color component control unit according to the predetermined image format.

15. The image processing apparatus according to claim 6, further comprising:
a conversion and transfer unit that converts the processed color image signals stored in the storage unit to image signals in a predetermined image format designated by one of a system and a user, and transfers the image signals in the predetermined image format to an external device, wherein
the conversion and transfer unit comprises a second color component control unit that conducts one of or both of a chromatic color pixel generation processing and an achromatic color pixel generation processing to the processed color image signals stored in the storage unit according to information on the attributes determined from the image signals stored in the storage unit, and
the second color component control unit conducts one of or both of the chromatic color pixel generation processing and the achromatic color pixel generation processing again to the processed color image signals stored in the storage unit according to the information on the attributes determined from the processed color image signals stored in the storage unit, and transfers the resultant image signals to the external device.

16. The image processing apparatus according to claim 15, wherein
the second color component control unit conducts one of or both of the chromatic color pixel generation processing and the achromatic color pixel generation processing again to the processed color image signals stored in the storage unit according to the attributes of the target pixel determined by the first segmentation unit, and
the conversion and transfer unit transfers the image signals obtained due to the processing by the second color component control unit to the external device.

17. The image processing apparatus according to claim 15, wherein
the conversion and transfer unit stores a content of the processing conducted to the image signals in header information and transfers the header information to the external device when transferring the image signals to the external device.

18. The image processing apparatus according to claim 15, further comprising an input unit that inputs image signals from the external device, wherein
the second segmentation unit determines attributes of the image signals input from the external device, and
the conversion and transfer unit controls a black character extraction method executed by the second segmentation unit according to the header information attached to the image signals.

19. The image processing apparatus according to claim 15, wherein
the storage unit stores image data input from the external device, and
if the second segmentation unit reads the image signals stored in the storage unit, detects the attributes of the target pixel, and determines that header information indicating a content of the processing is not attached to the image signals, the conversion and transfer unit controls the second segmentation unit to restrict black character extraction or not to conduct the black character extraction.

20. An image processing apparatus comprising:
an input unit that inputs color image signals; and
a magnification unit that magnifies the color image signals input in such a manner that predetermined color information included in the color image signals before magnifying the color image signals are retained even after magnifying the color image signals.

21. The image processing apparatus according to claim 20, wherein
the predetermined color information includes a ratio of a plurality of color component signals.

22. The image processing apparatus according to claim 21, wherein the magnification unit includes
a first magnification unit that magnifies at least one component signal of the color image signals represented by the plurality of color component signals; and
a second magnification unit that magnifies at least one component signal, other than that has been magnified by the first magnification unit, of the color image signals while referring to the color image signals that is magnified and that is not magnified by the first magnification unit.

23. The image processing apparatus according to claim 20, wherein
the predetermined color information includes at least color difference information.

24. The image processing apparatus according to claim 23, wherein the color image signals includes a luminance signal and a color difference signal, and the magnification unit includes
a luminance signal magnification unit that magnifies the luminance signal; and
a color difference signal magnification unit magnifies the color difference signals in a manner that is different from magnification of the luminance signal magnification unit by the luminance signal.

25. The image processing apparatus according to claim 24, wherein
the color difference signal magnification unit performs magnification in such a manner that a reference pixel area becomes narrower as compared with a reference pixel area that is obtained when the luminance signal magnification unit performs the magnification.

26. The image processing apparatus according to claim 24, wherein the luminance signal magnification unit and the color difference signal magnification unit magnify corresponding signals by giving weight parameters to peripheral pixels, and
the weight parameter set by the luminance signal magnification unit are different from that set by the color difference signal magnification unit.

27. The image processing apparatus according to claim 20, wherein
the magnification unit conducts different two-dimensional magnification setting processings in a longitudinal direction and a lateral direction of an image, respectively.

28. An image processing apparatus comprising:
an input unit that inputs color image signals in which code information representing a feature of an image is buried;
a magnification unit that magnifies the color image signals input in such a manner that the code information buried in the color image signals before magnifying the color image signals are retained even after magnifying the color image signals; and
an image processing unit that conducts an image processing to the color image signals magnified.

29. The image processing apparatus according to claim 28, wherein
the code information includes a predetermined color component in the color image signals.

30. The image processing apparatus according to claim 28, wherein
the code information is allocated at least one signal of a plurality of color components in the color image signals as a code signal representing a feature of an image and buried in the at least one signal.

31. The image processing apparatus according to claim 28, further comprising a code information recognition unit that recognizes the code information buried in the color image signals input, wherein
the magnification unit magnifies the color image signals according to the code information recognized.

32. The image processing apparatus according to claim 28, further comprising:
a segmentation unit that determines an area having a predetermined feature in the color image signals input; and
a code burying unit that buries the code information in the area determined to have the predetermined feature of the color image signals input.

33. The image processing apparatus according to claim 28, wherein the magnification unit includes
a first selective processing unit that processes a pixel, in the color image signals, that has the code information buried, in such a manner that the code information is retained even after magnifying the color image signals; and
a second selective processing unit that processes a pixel, in the color image signals, that has no code information buried, in such a manner that the pixel in question is not converted to a pixel having the code information after magnifying the color image signals.

34. An image processing system comprising:
an input unit that inputs color image signals;
a first segmentation unit that determines attributes of a target pixel for the color image signals;
a color component control unit that conducts a predetermined processing to color components of the target pixel based on the attributes of the target pixels determined to thereby generate processed color image signals;
a second segmentation unit that determines attributes of the target pixel for the processed color image signals; and
an image processing unit that conducts an image processing to the processed color image signals based on the attributes of the target pixel determined by the second segmentation unit.

35. The image processing system according to claim 34, wherein
the first segmentation unit determines whether the target pixel is any one of a black character pixel and a non-black character pixel based on the attributes of the target pixel,
the color component control section increases the color components of the target pixel upon the first segmentation unit determining that the target pixel is the non-black character pixel,
the second segmentation unit detects a black character pixel by analyzing at least color components of the processed color image signals, and
the image processing unit conducts the image processing to the processed color image signals based on the black character pixel detected.

36. The image processing system according to claim 35, wherein
the color component control unit performs an achromatic color pixel generation processing for any one of reducing and removing the color components of the target pixel that is determined by the first segmentation unit to be the black character pixel.

37. The image processing system according to claim 34, wherein
the first segmentation unit determines whether the target pixel is any one of a colored character pixel and a non-colored character pixel based on the attributes of the target pixel,
the color component control section increases the color components of the target pixel upon the first segmentation unit determining that the target pixel is the non-colored character pixel,
the second segmentation unit detects a colored character pixel by analyzing at least color components of the processed color image signals, and
the image processing unit conducts the image processing to the processed color image signals based on the colored character pixel detected.

38. The image processing system according to claim 34, wherein
the first segmentation unit determines whether the target pixel is any one of a character pixel and a non-character pixel based on the attributes of the target pixel,
the color component control section increases the color components of the target pixel upon the first segmentation unit determining that the target pixel is the non-character pixel,
the second segmentation unit detects a character pixel by analyzing at least color components of the processed color image signals, and
the image processing unit conducts the image processing to the processed color image signals based on the character pixel detected.

39. The image processing system according to claim 34, further comprising a storage unit that stores the processed color image signals, wherein
the second segmentation unit determines the attributes of the target pixel based on the processed color image signals stored in the storage unit.

40. The image processing system according to claim 34, further comprising:
a compression unit that compresses the processed color image signals to thereby generate compressed processed color image signals;
a storage unit that stores the compressed processed color image signals; and
an expansion unit that expands the compressed processed color image signals stored in the storage unit to thereby generate expanded processed color image signals, wherein
the second segmentation unit determines the attributes of the target pixel based on the expanded processed color image signals stored in the storage unit.

41. The image processing system according to claim 40, wherein
the compression unit conducts a nonreversible compression processing to the processed color image signals.

42. The image processing system according to claim 40, wherein
the compression unit converts the processed color image signals to luminance and color difference signals and then compresses the processed color image signals.

43. The image processing system according to claim 35, wherein
the color component control unit increases the color components upon the color components of the target pixel, attributes of which are determined, being smaller than a predetermined value.

44. The image processing system according to claim 35, wherein
the color component control unit increases the color components for an image area in which a probability of erroneously detecting the non-black character pixel as the black character pixel is high when the second segmentation unit detects the black character pixel than other areas or for increasing the color components only of the image area in which the probability of erroneously detecting the non-black character pixel as the black character pixel is high.

45. The image processing system according to claim 34, further comprising:
a conversion and transfer unit that
converts the processed color image signals into image signals in a predetermined image format that is designated by one of a system and a user,
transfers the image signals in the predetermined image format to an external device, and
controls the color component control unit according to the predetermined image format.

46. The image processing system according to claim 39, further comprising:
a conversion and transfer unit that converts the processed color image signals stored in the storage unit to image signals in a predetermined image format designated by one of a system and a user, and transfers the image signals in the predetermined image format to an external device, wherein
the conversion and transfer unit comprises a second color component control unit that conducts one of or both of a chromatic color pixel generation processing and an achromatic color pixel generation processing to the processed color image signals stored in the storage unit according to information on the attributes determined from the image signals stored in the storage unit, and
the second color component control unit conducts one of or both of the chromatic color pixel generation processing and the achromatic color pixel generation processing again to the processed color image signals stored in the storage unit according to the information on the attributes determined from the processed color image signals stored in the storage unit, and transfers the resultant image signals to the external device.

47. An image processing method comprising:
inputting color image signals;
determining attributes of a target pixel for the color image signals;
conducting a predetermined processing to color components of the target pixel based on the attributes of the target pixels determined to thereby generate processed color image signals;
determining attributes of the target pixel for the processed color image signals; and
conducting an image processing to the processed color image signals based on the attributes of the target pixel determined for the processed color image signals.

48. The image processing method according to claim 47, wherein
the determining attributes of a target pixel for the color image signals includes determining whether the target pixel is any one of a black character pixel and a non-black character pixel based on the attributes of the target pixel,
the predetermined processing includes increasing the color components of the target pixel upon it is determined at the determining attributes of a target pixel for the color image signals that the target pixel is the non-black character pixel,
the determining attributes of the target pixel for the processed color image signals includes detecting a black character pixel by analyzing at least color components of the processed color image signals, and
the conducting the image processing includes processing the processed color image signals based on the black character pixel detected.

49. The image processing apparatus according to claim 48, wherein
the conducting the predetermined processing includes performing an achromatic color pixel generation processing for any one of reducing and removing the color components of the target pixel that is determined at the determining attributes of a target pixel for the color image signals to be the black character pixel.

50. The image processing method according to claim 47, wherein
the determining attributes of a target pixel for the color image signals includes determining whether the target pixel is any one of a colored character pixel and a non-colored character pixel based on the attributes of the target pixel,
the predetermined processing includes increasing the color components of the target pixel upon it is determined at the determining attributes of a target pixel for the color image signals that the target pixel is the non-colored character pixel,
the determining attributes of the target pixel for the processed color image signals includes detecting a colored character pixel by analyzing at least color components of the processed color image signals, and
the conducting the image processing includes processing the processed color image signals based on the colored character pixel detected.

51. The image processing method according to claim 47, wherein
the determining attributes of a target pixel for the color image signals includes determining whether the target pixel is any one of a character pixel and a non-character pixel based on the attributes of the target pixel,
the predetermined processing includes increasing the color components of the target pixel upon it is determined at the determining attributes of a target pixel for the color image signals that the target pixel is the non-character pixel,
the determining attributes of the target pixel for the processed color image signals includes detecting a character pixel by analyzing at least color components of the processed color image signals, and
the conducting the image processing includes processing the processed color image signals based on the character pixel detected.

52. An image processing method comprising:
inputting color image signals; and
magnifying the color image signals input in such a manner that predetermined color information included in the color image signals before magnifying the color image signals are retained even after magnifying the color image signals.

53. The image processing method according to claim 52, wherein
the predetermined color information includes a ratio of a plurality of color component signals.

54. The image processing method according to claim 53, wherein the magnifying includes
first magnifying at least one component signal of the color image signals represented by the plurality of color component signals; and
second magnifying at least one component signal, other than that has been magnified at the first magnifying, of the color image signals while referring to the color image signals that is magnified and that is not magnified at the first magnifying.

55. The image processing method according to claim 52, wherein
the predetermined color information includes at least color difference information.

56. The image processing method according to claim 55, wherein the color image signals includes a luminance signal and a color difference signal, and the magnifying includes
magnifying the luminance signal; and
magnifying the color difference signals in a manner that is different from magnifying the luminance signal.

57. The image processing method according to claim 56, wherein
the magnifying the color difference signals includes magnifying in such a manner that a reference pixel area becomes narrower as compared with a reference pixel area that is obtained when magnifying the luminance signal.

58. The image processing method according to claim 56, wherein the luminance signal and the color difference signal are magnified by giving weight parameters to peripheral pixels, and
the weight parameter for the luminance signal are different from that for the color difference signal.

59. The image processing method according to claim 52, wherein
the magnifying includes magnifying in two different directions of an image.

60. An image processing method comprising:
inputting color image signals in which code information representing a feature of an image is buried;
magnifying the color image signals input in such a manner that the code information buried in the color image signals before magnifying the color image signals are retained even after magnifying the color image signals; and
conducting an image processing to the color image signals magnified.

61. The image processing method according to claim 60, wherein
the code information includes a predetermined color component in the color image signals.

62. The image processing method according to claim 60, wherein
the code information is allocated at least one signal of a plurality of color components in the color image signals as a code signal representing a feature of an image and buried in the at least one signal.

63. The image processing method according to claim 60, further comprising recognizing the code information buried in the color image signals input, wherein
the magnifying includes magnifying the color image signals according to the code information recognized.

64. The image processing method according to claim 60, further comprising:
determining an area having a predetermined feature in the color image signals input; and
burying the code information in the area determined to have the predetermined feature of the color image signals input.

65. The image processing method according to claim 60, wherein the magnifying includes
processing a pixel, in the color image signals, that has the code information buried, in such a manner that the code information is retained even after magnifying the color image signals; and
processing a pixel, in the color image signals, that has no code information buried, in such a manner that the pixel in question is not converted to a pixel having the code information after magnifying the color image signals.
